(19) United States
(12) Patent Application Publication
(10) Pub. No.: US 2016/0267219 A1
(43) Pub. Date: Sep. 15, 2016

(54) SITE-SPECIFIC FRAGMENT IDENTIFICATION GUIDED BY SINGLE-STEP FREE ENERGY PERTURBATION CALCULATIONS

(71) Applicant: University of Maryland, Baltimore, Baltimore, MD (US)

(72) Inventors: Alexander D. Mackerell, Baltimore, MD (US); E. Prabhu Raman, Columbia, MD (US)

(21) Appl. No.: 15/162,005

(22) Filed: May 23, 2016

Related U.S. Application Data
(63) Continuation of application No. 14/387,054, filed on Sep. 22, 2014.
(60) Provisional application No. 61/613,145, filed on Mar. 20, 2012.

(51) Int. Cl. G06F 19/12; G06F 19/00; G06F 19/16

(52) U.S. Cl. CPC G06F 19/12; G06F 19/16; G06F 19/701

(57) ABSTRACT

A method and system is disclosed for estimating the difference between binding free energies of molecules.

### RELATED APPLICATIONS

This application claims priority to U.S. Provisional Application No. 61/613,145, filed Mar. 20, 2012, the entire contents of which being hereby incorporated at reference, the same as if set forth at length.

### STATEMENT OF FEDERALLY SPONSORED RESEARCH AND DEVELOPMENT

This invention was made with government support under Grant Numbers CA120215, CA107331, and MH092940 awarded by The National Institutes of Health, Grant No. CHE-0823198 awarded by the NSF, and Grant No. 103664 awarded by the Samuel Waxman Cancer Research Foundation. The government has certain rights in the invention.

### BACKGROUND

1. Field of the Application

The present application relates generally to methods of screening for compounds. More particularly, the present application relates to methods of identifying binding sites of representative chemical entities to be used for computational fragment-based drug design.

2. Discussion of the Background

Fragment based drug discovery (FBDD) has emerged as a promising alternative to high throughput screening (HTS) for the discovery of high affinity inhibitors. Compared to HTS, by identifying compounds that can ultimately be modified or linked into higher potency inhibitors, FBDD potentially provides more efficient coverage of chemical space while screening a smaller number of candidate molecules. The first step in FBDD involves the detection of low molecular weight compounds (˜150 Da) bound to the target protein surface. The small compounds, or fragments, act as the starting point for the application of structure-based approaches to develop novel lead compounds. This may be achieved by either decorating the fragment with functional groups or linking fragments bound to neighboring sites on the target to improve the binding affinity. However, for any of these approaches, atomic detail information of the protein-fragment complex is required, information that can be difficult to obtain due to weak binding affinity and inherent limitations of X-ray crystallography or NMR spectroscopy.

Computational methods represent successful alternatives to experimental approaches to drug discovery and design. Docking based virtual screening has been used to effectively initiate a number of drug discovery campaigns, though it is limited in that it relies on pre-existing compounds. De novo drug design on the other hand involves the creation of novel chemical entities, with fragment-based methods representing the starting point for most de novo design strategies. In these approaches the type and location of fragments binding to the protein surface are detected, followed by the linking of those fragments that bind to neighboring sites on a protein. Towards this end computational fragment docking has shown great potential and recent developments have moved beyond the traditional limitations of the method associated with the use of a rigid protein and absence of aqueous solvation, among others.

An earlier approach developed in our laboratory involves MD (molecular dynamics) simulations of the target protein in an aqueous solution of organic molecules representative of fragments of more complex drug-like molecules. In that approach, so-called Site Identification by Ligand Competitive Saturation (“SILCS”), flexibility of the protein and fragments is included explicitly as is the aqueous environment allowing exhaustive MD simulations to yield an ensemble of the distribution of the fragments and of water on the protein surface. This ensemble, in combination with control simulations in the absence of the target protein allows for generation of normalized three-dimensional (“3D”) probability distributions, so-called, “FragMaps” that identify the favorable locations of different functional groups on the entire protein surface. Conversion of the FragMaps to free energies, based on a Boltzmann distribution, yields Grid Free Energies (GFEs) that may be used to calculate free-energy contributions of fragments to ligand binding. The success of the approach was seen in the overlap of FragMaps/low energy regions of GFEs of fragments with crystallographic positions of functional groups of similar chemical type in both peptide-protein and inhibitor-protein complexes.

A disadvantage of the SILCS methodology is the limited number of ligand types that can be included in the MD simulations. In published studies to date only propane and benzene have been included, along with water, limiting the information content from SILCS to aliphatic, aromatic, hydrogen bond donor and hydrogen bond acceptor functional classes. While ongoing studies in our laboratory indicate that a range of other small ligands may be used, and other ligands have been used in similar studies, this represents a significant limitation.

### DESCRIPTION OF THE DRAWINGS

FIG. 1. An illustration of an exemplary embodiment showing six different orientations generated for fluorobenzene in the binding pocket of α-thrombin obtained by applying the Single Step Free Energy Perturbation (“SSFEP”) protocol to benzene conformations from the α-thrombin SILCS simulations. 20 most favorable conformations in each orientation are depicted with the fluorine atom colored differently for each orientation.

FIG. 2. Relative hydration free energies of benzene analogues with respect to benzene in an exemplary embodiment computed using the SSFEP protocol versus comparative embodiments using (a) experimental data (from Mobley et al.) and (b) thermodynamic integration (TI) data. The length of the error bars in the computed values is equal to twice the standard deviation in the six different set of calculations corresponding to the six orientations of the benzene analogue. The same data are shown in the table below. The units are kcal/mol.

FIG. 3. Presents data for various exemplary and comparative embodiments (a) 14 substitutions on the phenyl ring of α-thrombin inhibitor ATI shown in (b). (a) also lists the experimental Kᵢ values, converted experimental ΔΔG and computed ΔΔG values. Experimental ΔΔG value for each analogue was obtained as the difference between RT ln Kᵢ values of the analogue and the unsubstituted compound 5. Computed values were obtained using the SSFEP protocol applied to thrombin-ATI MD simulations and are averaged over the 4 5 ns blocks. (c) plots computed vs. experimental values. Error bars indicate ±1 standard deviation resulting from the 4 blocks of data used in averaging. The units are kcal/mol.

FIG. 4. Presents data for various exemplary and comparative embodiments (a) Parent MAP kinase inhibitor (“MKI”), (b) 16 substitutions forming the congeneric series with their experimentally obtained concentration at which 50% inhibition occurs, or pIC50, converted experimental and computed ΔΔG values using protein restrained simulation. Experimental ΔΔG values for each analogue were obtained as the difference of RT ln 10^{-pIC50} transformed values of the analogue and that of the unsubstituted compound 1. (c) Computed vs. experimental ΔΔG values with the computed values obtained by averaging 4 5 ns blocks from the SSFEP protocol applied to a phenyl ring conformation from the simulations involving the full ligand. Error bars indicate ±1 standard deviation resulting from the 4 blocks of data used in averaging. (d) same as (c), but with protein restraints. The data plotted are the same as that listed in (a). The units are kcal/mol.

FIG. 5. Presents data for various exemplary and comparative embodiments (a) Crystal structure of apo α-thrombin (PDB 3D49) overlaid with benzene FragMap displayed at a grid free energy cutoff of −1.2 kcal/mol in purple wireframe representation. Green spheres show the cluster centers of the favorable benzene binding regions. The encircled region shows the S1-pocket. (b) the conformations selected from the SILCS simulations for SSFEP calculations. (c) and (d) Relative binding free energies of benzene analogues computed using the SSFEP protocol applied to SILCS trajectories versus experimental data. The units are kcal/mol.

FIG. 6. Presents data for an exemplary embodiment showing 20 most favorable conformations of fluorobenzene, chlorobenzene and toluene obtained from the SSFEP calculations corresponding to the appropriate orientations overlaid on the crystal conformations 2ZDV, 2ZC9 and 2ZFO in panels (a), (b) and (c), respectively.

FIG. 7. Presents data for various exemplary and comparative embodiments (a) Crystal structure of P38 MAP kinase overlaid with benzene FragMap displayed at a grid free energy cutoff of −1.2 kcal/mol in purple wireframe representation. Green spheres show the cluster centers of the favorable benzene binding regions. The encircled region shows the binding pocket. (b) Conformations selected from the SILCS simulations for SSFEP calculations. (c) SSFEP computed relative binding free energies from SILCS simulation data vs. experimental data. (d) Overlap coefficient computed per Eqn 7 for 7 and 8 singly substituted benzene analogues of P38MK and thrombin vs. absolute error in prediction. The units of energy are kcal/mol.

FIG. 8. Presents data for various exemplary and comparative embodiments (a) Convergence data for the thermodynamic integration (TI) calculations to determine relative hydration free energies of benzene analogues. The sum of the alchemical TI calculations in the forward and reverse directions, which ideally should be 0, serves as a convergence metric. (b) Relative hydration free energies ΔΔG computed using TI vs. experiment. The units are kcal/mol.

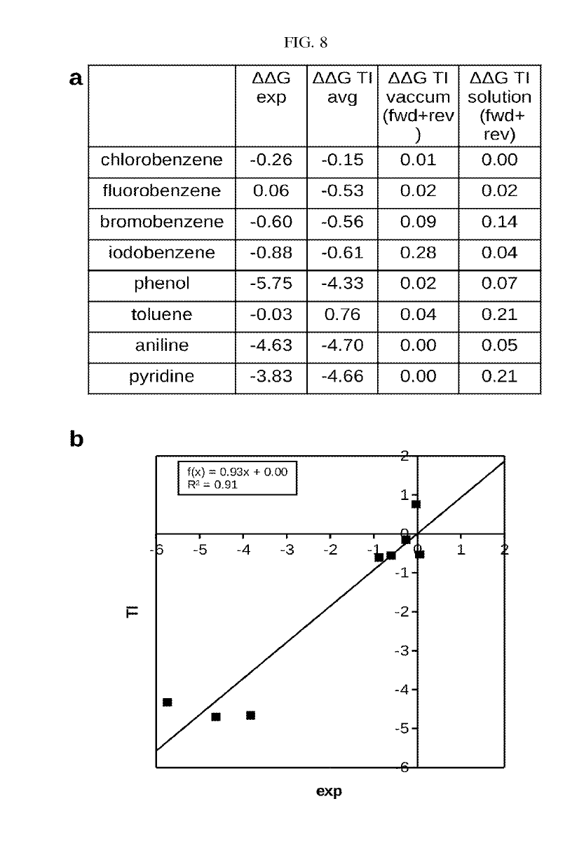

FIG. 9. Presents data for various exemplary and comparative embodiments showing SSFEP computed vs. experimental relative binding free energies of (a) thrombin and (b) P38 MAP kinase ligands. The SSFEP computation was performed without removing the rotation of the phenyl ring conformation with respect to the reference conformation. P38MK data shown in panel b is from the protein-restrained simulation. The units arc kcal/mol.

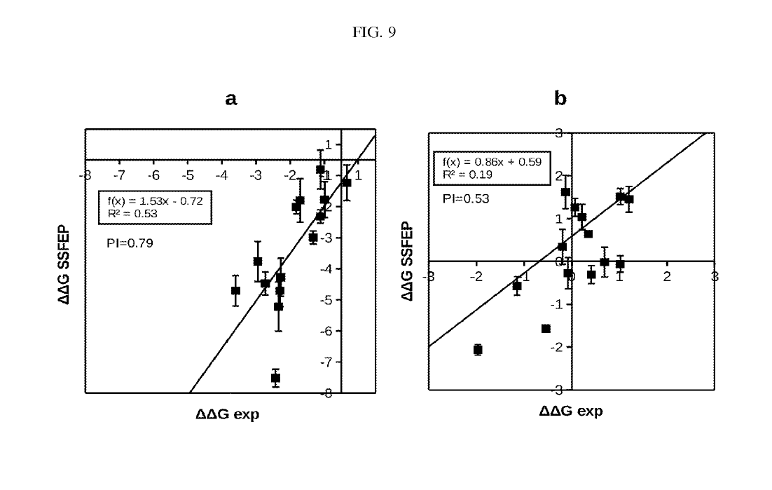

FIG. 10. Presents data for various exemplary and comparative embodiments showing correlation between predicted ΔΔG values of benzene analogues in thrombin S1-pocket computed using the SSFEP protocol using four different reference structures. Ref1 (blue) is the benzene from the crystal conformation of the phenyl ring in the inhibitor ATI used herein. Ref2 (red) and Ref3 (grey) are arbitrarily chosen conformations from the SILCS simulations. Ref4 (orange) is chosen based on best overlap with the benzene FragMap constructed from the SILCS simulations. The inter-benzene 1-2, 1-3 and 1-4 RMSDs are 0.98 1.25 and 1.30 Å respectively.

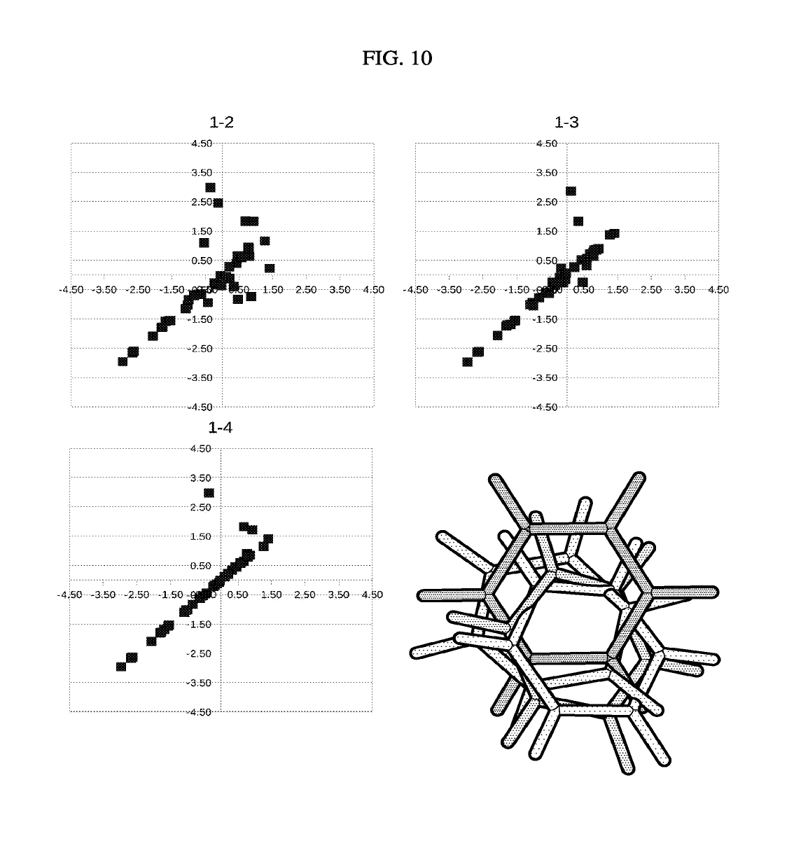

FIG. 11. Presents exemplary data in tabular form (Table 1). Free energy differences, ΔΔG, for single step free energy perturbations of benzene to chlorobenzene or toluene in two pockets on the S100b protein. Free energies in kcal/mol and position indicates which of the 6 individual hydrogens on benzene was replaced to create chlorobenzene or toluene. ΔΔG1 and ΔΔG2 indicate free energies calculated with two separate ensembles of conformations obtained from the SILCS trajectories, which were averaged for final compound selection.

### DESCRIPTION OF THE SEVERAL EMBODIMENTS

One embodiment provides a method for estimating the difference between binding free energies of molecules, said method carried out on a computer and including:

carrying out a molecular dynamics simulation or a Monte Carlo simulation on a large molecule and at least one small molecule, wherein the small molecule is not an unphysical reference state, to obtain multiple conformations of said large and small molecules in a binding environment of the large molecule;

determining an energy of the small molecule in said binding environment for said conformations;

replacing one or more atoms of said small molecule with one or more different atoms for each of said conformations, to obtain a modified small molecule in said binding environment;

determining an energy of the modified small molecule in said binding environment for said conformations, wherein a molecular dynamics simulation or Monte Carlo simulation is not carried out on said modified small molecule; and

carrying out a single step perturbation calculation using said energies of the small and modified small molecules, to obtain the estimated difference between the binding free energies of said small and modified small molecules to said large molecule.

One embodiment provides a computer readable medium encoded with a computer program for estimating the difference between binding free energies of molecules and including:

a means for carrying out a molecular dynamics simulation or a Monte Carlo simulation on a large molecule and at least one small molecule, wherein the small molecule is not an unphysical reference state, to obtain multiple conformations of said large and small molecules in a binding environment of the large molecule;

a means for determining an energy of the small molecule in said binding environment for said conformations;

a means for replacing one or more atoms of said small molecule with one or more different atoms for each of said conformations, to obtain a modified small molecule in said binding environment;

a means for determining an energy of the modified small molecule in said binding environment for said conformations, wherein a molecular dynamics simulation or Monte Carlo simulation is not carried out on said modified small molecule; and

a means for carrying out a single step perturbation calculation using said energies of the small and modified small molecules, to obtain the estimated difference between the binding free energies of said small and modified small molecules to said large molecule.

One embodiment includes methods and systems for drug discovery and design through the site-specific identification of favorable chemical modifications. In one embodiment, a method is provided for discovering a drug comprising having a target of interest, identifying the binding sites of representative chemical entities on the entire target surface using an in-silico Site Identification by Ligand Competitive Saturation (“SILCS”), and identifying chemical modifications using the chemical entities identified in SILCS in conjunction with a free energy perturbation formula, wherein the free energy change estimated by said formula identifies potential compounds and/or compound modifications of interest. Another embodiment includes a non-transitory computer readable medium for identifying compounds of interest by having a target of interest, identifying the binding sites of representative chemical entities on the entire target site surface using SILCS, and identifying chemical modifications using the chemical entities identified in SILCs in conjunction with a free energy perturbation formula, wherein the free energy change estimated by said formula identifies potential compounds and/or compound modifications of interest. Another embodiment includes a system that is either capable of or configured to carry out one or more methods provided herein. The methods and systems identified herein allow for a broader range of drug design than any other known method.

The present method and system overcome the disadvantages of the SILCS method alone. The present inventors have found that a structural ensemble obtained from SILCS simulations of a large molecule in the presence of a limited set of small molecules can be used to estimate the change in the binding free energy associated with modifications of those small molecules, such that the relative affinities of a wide range of small molecules can be rapidly predicted. With the present method and system, the number of possible small molecules that can be predicted to bind favorably to a binding site of a large molecule can be significantly increased, thereby increasing the utility of SILCS in a de-novo FBDD strategy.

In one embodiment, a Single Step Free Energy Perturbation (SSFEP) method is implemented to identify site-specific favorable modifications to fragments thereby extending the SILCS methodology. Conventional “One Step Perturbation” approaches have been used for the calculation of relative hydration free energies and relative binding free energies of drug-like molecules involving differences of many non-hydrogen atoms. Unlike the conventional approach, one embodiment of the present method and system involves obtaining a conformational ensemble of small molecules, which small molecules are not an unphysical reference state, from molecular dynamics simulations, such as SILCS, or Monte Carlo simulations rather than using a fictitious reference compound that involves “soft-core” interactions, and using that ensemble in conjunction with the free energy perturbation formula to estimate the free energy change caused due to a chemical modification of the small molecules used in the initial molecular dynamics or Monte Carlo simulation. As shown in the Examples, the method and system presented have been validated against experimental relative hydration free energies of benzene analogues and relative binding free energies of drug-sized molecules containing a substituted phenyl ring.

In one embodiment, the SILCS approach identifies the binding sites of representative chemical entities on the entire protein surface, information that can be applied for computational fragment-based drug design. In one embodiment, an efficient computational protocol is presented that uses sampling of the protein-fragment conformational space obtained from molecular dynamics simulations, for example, the SILCS simulations, or Monte Carlo simulations and performs single step free energy perturbation (SSFEP) calculations to identify site-specific favorable chemical modifications of benzene involving substitutions of one or more ring hydrogens with individual non-hydrogen atoms. In one embodiment, the SSFEP method, in combination with SILCS, is able to capture the experimental trends in relative hydration free energies of benzene analogues and for two datasets of experimental relative binding free energies of congeneric series of ligands of the proteins α-thrombin and P38 MAP kinase. The approach includes a protocol in which data obtained from SILCS simulations of the proteins is first analyzed to identify favorable benzene binding sites following which an ensemble of benzene-protein conformations for that site is obtained. The SSFEP protocol applied to that ensemble results in good reproduction of experimental free energies of the α-thrombin ligands, but not for P38 MAP kinase ligands. Comparison with results from a P38 full-ligand simulation and analysis of conformations reveals the reason for the poor agreement being the connectivity with the remainder of the ligand, a limitation inherent in fragment-based methods. Since the SSFEP approach can identify favorable benzene modifications as well as identify the most favorable fragment conformations, however, the obtained information can be of value for fragment linking or structure-based optimization, and does not detract from the method.

So long as it is amenable to in silico molecular dynamics simulation or a Monte Carlo simulation, the large molecule—sometimes called the target molecule herein—is not particularly limited. For example, the large molecule may be a complete molecule, or it may be less than a complete molecule, i.e., it may be only a portion of a molecule such as a binding site, ligand-binding domain, surface, or the like, which is sufficiently representative of a binding environment. The molecular weight of the large molecule is similarly not limiting. For example, in some embodiments, the large molecule may have a molecular weight ranging from 50 Da and higher. This range includes all values and subranges therebetween, including molecular weights of 100, 200, 250, 500, 750, 1000, 1100, 1500, 2000, 2500, 5000, 7500, 10,000, 25,000, 50,000, 75,000, 100,000, 125,000, 200,000, 250,000, 300,000, 400,000, 500,000 Da and higher, or any combination thereof. In one embodiment, the molecular weight of the large molecule ranges from 50 to 500,000 Da.

Some examples of the large molecule, which are not intended to be limiting, include nucleotide, oligonucleotide, DNA, single-stranded DNA, RNA, carbohydrate, glycolipid, protein, glycoprotein, receptor, phospholipid, ribosomal protein, antibody, F(ab) fragment, F(ab)₂ fragment, chimeric antibody, humanized antibody, human antibody, peptide, aptamer, complex thereof, ligand-bound complex thereof, fragment-bound complex thereof, ligand-binding domain thereof, binding site thereof, surface thereof, and combination thereof.

The large molecule may be any of hydrated, dehydrated, solvated, unsolvated, denatured, or in aqueous or ionic solution. The large molecule may be in a vacuum, water, single solvent, or ionic solvent. In one embodiment the large molecule is in water or physiological solution.

The large molecule may be an unphysical reference state or a physical reference state, or a combination thereof. The large molecule may have any interactions, for example, soft-core, non-soft core, non-bonded, unperturbed, or combination thereof. In one embodiment, different portions of the large molecule may have different interactions. For example one portion may have soft-core interactions, and another portion may have unperturbed non-bonded interactions. In one embodiment, the large molecule does not have unphysical/soft-core interactions.

In one embodiment, the large molecule is a solvated protein in aqueous solution.

Some examples of large molecules may be found in U.S. patent application Ser. No. 13/265,568, filed Oct. 21, 2011, the entire contents of which are hereby incorporated by reference.

So long as it is amenable to in silico molecular dynamics simulation or a Monte Carlo simulation, the small molecule is not particularly limited. In one embodiment, the small molecule is not an unphysical reference state. In one embodiment, the small molecule does not have soft-core interactions. In one embodiment, the small molecule has unperturbed non-bonded interactions. When discussed in the generic, the terms, small molecule, fragment, and ligand may be used interchangeably herein.

The molecular weight of the small molecule is not particularly limited and may range from 10 Da or more. In one embodiment, the term fragment may refer to a small molecule having a molecular weight of ≦150 Da. In one embodiment, the term ligand may refer to a small molecule having molecular weights of ≧150 Da and ≦500 Da. These ranges include all value and subranges therebetween for the small molecule, including 10, 20, 30, 40, 50, 60, 70, 80, 90, 100, 125, 150, 175, 200, 250, 500 Da, and higher, or any combination thereof. In one embodiment, a ligand may refer to a small molecule having a higher molecular weight, more than one fragment, or both. In one embodiment, a fragment may refer to a small molecule having mainly a single functional group, e.g., a hydrogen bond donor, hydrogen bond acceptor, and the like, which hinds to the large molecule. In one embodiment, the term fragment may refer to a small molecule having a lower molecular weight. In one embodiment, a ligand may refer to a small molecule having more than one fragments linked together. In one embodiment, in the case of certain ligands, one part of the small molecule may be covalently linked to one area of the large molecule surface; and another part of the small molecule is a fragment that is not so linked and is available for investigating the binding free energy to another area of the large molecule.

The small molecule may be any of hydrated, dehydrated, solvated, unsolvated, denatured, or in aqueous or ionic solution. The small molecule may be in a vacuum, water, single solvent, or ionic solvent. In one embodiment the large molecule is in water or physiological solution.

In one embodiment, the small molecule is water or a hydrocarbon. In one embodiment, the small molecule is a straight or branched, acyclic or cyclic, saturated or unsaturated, substituted or unsubstituted, aromatic or non-aromatic C₁-C₂₀ hydrocarbon. If further substituted, the hydrocarbon may have more than 20 carbons. The hydrocarbon may contain one or more heteroatoms.

In one embodiment, the small molecule is a functional group. Non-limiting examples of functional groups include a carbonyl group, a carboxylic acid group, a carboxylate group, a hydroxy group, an oxo group, a mercapto group, an alkylthio group, an alkoxy group, a nitro group, an amino group, an amidine group, an amide group, a carbamoyl group, a sulfonyl group, a phospho group, or a combination thereof. In one embodiment, the small molecule includes a functional group portion and another portion which is complexed to or linked to the large molecule.

In one embodiment, two or more different small molecules participate in the MD or Monte Carlo simulations. In one embodiment, one or more than one of the same small molecule participates in the simulations.

In one embodiment, the small molecule may be an acyclic, straight or branched, substituted or unsubstituted, saturated hydrocarbon. In one embodiment, the hydrocarbon is a C₁-C₂₀ alkane, which may suitably include C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, and C₂₀ alkane. In one embodiment, one or more hydrogens may be optionally and independently replaced by one or more substituent groups. In one embodiment, one or more carbon atoms may be optionally and independently replaced with one or more heteroatoms such as O, S, N, B, P, or any combination thereof. Some examples, which are not intended to be limiting, include methane, ethane, n-propane, isopropane, n-butane, iso-butane, secondary-butane, tertiary-butane, and the like.

In one embodiment, the small molecule may be a mono- or polycyclic, substituted or unsubstituted, saturated or unsaturated cyclic hydrocarbon. In one embodiment, the hydrocarbon is a C₃-C₂₀ cyclic compound, which may suitably include C₃, C₄, C₅, C₆, C₇, C₈, C₉, C₁₀, C₁₁, C₁₂, C₁₃, C₁₄, C₁₅, C₁₆, C₁₇, C₁₈, C₁₉, and C₂₀ cyclic compounds. In one embodiment, the cycloalkyl group is substituted or unsubstituted, saturated or unsaturated, mono-, bi-, tri-, or poly-cyclic, or any combination thereof. In one embodiment, one or more hydrogens may be optionally and independently replaced by one or more substituent groups. In one embodiment, the cycloalkyl group may have one or more sites of unsaturation, e.g., it may contain one or more double bond, one or more triple bond, or any combination thereof. In one embodiment, one or more carbon atoms may be optionally and independently replaced with one or more heteroatoms such as O, S, N, B, P, or any combination thereof. Some examples, which are not intended to be limiting, include cyclopropane, cyclobutane, cyclopentane, cyclohexane, cycloheptane, cyclooctane, cyclononane, cyclopentenane, cyclohexene, bicyclo[2.2.1]heptane, bicyclo[3.2.1]octane and bicyclo[5.2.0]nonane, and the like.

In one embodiment, the small molecule may be straight or branched, substituted or unsubstituted, unsaturated hydrocarbon. In one embodiment, the unsaturated hydrocarbon is a C₂-C₂₀ alkene, which may suitably include C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, and C₂₀ alkenes. In one embodiment, one or more hydrogens may be optionally and independently replaced by one or more substituent groups. In one embodiment, the alkene may have one or more than one degree of unsaturation. In one embodiment, one or more carbon atoms may be optionally and independently replaced with one or more heteroatoms such as O, S, N, B, P, or any combination thereof. Some examples, which are not intended to be limiting, including ethene, 1-propene, 2-propene, iso-propene, 2-methyl-1-propene, 1-butene, 2-butene, alkadiene, alkatriene, and the like.

In one embodiment, the small molecule is straight or branched, substituted or unsubstituted, hydrocarbon that contains one or more carbon-carbon triple bond. In one embodiment, alkyne is C₂-C₂₀ alkyne, which may suitably include C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, and C₂₀ alkyne compounds. In one embodiment, one or more hydrogens may be optionally and independently replaced by one or more substituent groups. In one embodiment, the alkyne may have one or more than one degree of unsaturation. In one embodiment, one or more carbon atoms may be optionally and independently replaced with one or more heteroatoms such as O, S, N, B, P,or any combination thereof. Some examples, which are not intended to be limiting, include alkadiyne, alkatriyne, acetylene, propyne, butyne, pentyne, and the like.

In one embodiment, the small molecule may be a substituted or unsubstituted, monocyclic or polycyclic aromatic hydrocarbon. In one embodiment, the aromatic hydrocarbon is a C₅-C₂₀ aromatic compound, which may suitably include C₅, C₆, C₇, C₈, C₉, C₁₀, C₁₁, C₁₂, C₁₃, C₁₄, C₁₅, C₁₆, C₁₇, C₁₈, C₁₉, and C₂₀ aromatic compounds. In one embodiment, one or more hydrogens may be optionally and independently replaced by one or more substituent groups. Some examples, which are not intended to be limiting, include benzene, naphthalene, tetrahydronaphthalene, phenanthrene, and the like.

In one embodiment, the small molecule may be substituted or unsubstituted, saturated or unsaturated, mono- or polycyclic hydrocarbon that contains one or more heteroatoms in one or more of the rings. In one embodiment, the heterocyclic compound is a C₃-C₂₀ heterocyclic group, which suitably includes C₃, C₄, C₅, C₆, C₇, C₈, C₉, C₁₀, C₁₁, C₁₂, C₁₃, C₁₄, C₁₅, C₁₆, C₁₇, C₁₈, C₁₉, and C₂₀ cyclic groups in which one or more ring carbons is independently replaced with one or more heteroatoms. In one embodiment, the heteroatoms are selected from one or more of N, O, or S, or any combination thereof. In one embodiment, the N or S or both may be independently substituted with one or more substituents. In one embodiment, the heterocyclic compound is substituted or unsubstituted, saturated or unsaturated, mono-, bi-, tri-, or poly-cyclic, or any combination thereof. In one embodiment, one or more hydrogens may be optionally and independently replaced by one or more substituent groups. In one embodiment, the heterocyclic group may include one or more carbon-carbon double bonds, carbon-carbon triple bonds, carbon-nitrogen double bonds, or any combination thereof. Some examples of heterocyclic compounds, which are not intended to be limiting, include azetidine, tetrahydrofuran, imidazolidine, pyrrolidine, piperidine, piperazine, oxazolidine, thiazolidine, morpholine, and the like.

In one embodiment, the small molecule may be a substituted or unsubstituted, monocyclic or polycyclic aromatic hydrocarbon in which one or more ring carbons is independently replaced with one or more heteroatoms selected from O, S and N. In one embodiment, the heteroaromatic compound is a C₅-C₂₀ heteroaromatic compound, which may suitably include C₅, C₆, C₇, C₈, C₉, C₁₀, C₁₁, C₁₂, C₁₃, C₁₄, C₁₅, C₁₆, C₁₇, C₁₈, C₁₉, and C₂₀ aromatic compounds in which one or more than one ring carbon is independently replaced with one or more heteroatoms. In one embodiment, the heteroaryl group may be substituted or unsubstituted. Some examples, which are not intended to be limiting, include pyridine, pyrazine, pyrimidine, pyridazine, thiene, furyl, imidazole, pyrrole, oxazole (e.g., 1,3-oxazolyl, 1,2-oxazolyl), thiazolyl (e.g., 1,2-thiazolyl, 1,3-thiazolyl), pyrazole, quinole, isoquinole, indole, and the like.

The small molecule hydrocarbon may be substituted, if desired, with one or more substituents. Some examples of substituents include a carbonyl group, a carboxylic acid group, a carboxylate group, an alkyl group, a cycloalkyl group, a halo group, an alkenyl group, an alkynyl group, a hydroxy group, an oxo group, a mercapto group, an alkylthio group, an alkoxy group, an aryl group, a heterocyclic group, a heteroaryl group, an aryloxy group, a heteroaryloxy group, an aralkyl group, a heteroaralkyl group, an aralkoxy group, a heteroaralkoxy group, a nitro group, an amino group, an alkylamino group, a dialkylamino group, an amidine group, an amide group, a carbamoyl group, an alkylcarbonyl group, an alkoxycarbonyl group, an alkylaminocarbonyl group, a dialkylamino carbonyl group, an arylcarbonyl group, an aryloxycarbonyl group, a sulfonyl group, an alkylsulfonyl group, an arylsulfonyl group, a phospho group, a perhaloalkyl group, a perhaloalkoxy group, a perhalocycloalkyl group, a perhaloalkenyl group, a perhaloalkynyl group, a perhaloaryl group, or a perhaloaralkyl group, or a combination thereof.

Examples of halo group include iodide, bromide, chloride, or fluoride.

In one embodiment, the small molecule is aliphatic or aromatic. In one embodiment, the aliphatic molecule is propane, butane, isobutene, isopentane, or a combination thereof. In one embodiment, the aromatic molecule is benzene, imidazole, phenol, aniline, pyridine, pyrrole, or combination thereof. In one embodiment, the small molecule is a hydrogen bond donor. In one embodiment, the hydrogen bond donor is water, hydrogen, hydroxyl, methanol, acetamide, imidazole, pyrrole, amide, or combination thereof. In one embodiment, the hydrogen bond acceptors are water oxygen, carbonyl, ether, acetone, formaldehyde, or combination thereof. In one embodiment, the small molecule is a dual functionality ligand, e.g., piperidine, piperazine, pyrrole, pyrrolidine, indole, methanol, phenol, imidazole, aniline, pyridine, acetone, or combination thereof.

Any of the small molecules may be modified as described herein to obtain the modified small molecule. When modifying the small molecule to obtain the modified small molecule, one or more than one atom of the small molecule may be replaced with a different atom. In one embodiment, one or more hydrogens in the small molecule are replaced with a corresponding number of one or more heavy (i.e., non-hydrogen) atoms. In one embodiment, one or more heavy atoms in the small molecule are replaced with a corresponding number of one or more different heavy atoms, one or more hydrogens, or any combination thereof. In one embodiment, only a single atom in the small molecule is replaced with a different atom, to obtain the modified small molecule. In one embodiment, one or more hydrogens in the small molecule is replaced with a functional group, e.g., a hydroxy group, amino group, or the like, to obtain the modified small molecule.

All or a portion of the small molecule may be rigid or non-rigid. In one embodiment, all or a portion of the small molecule is rigid. In one embodiment, all or a portion of the small molecule is non-rigid. In one embodiment, the small molecule is a rigid molecule. In one embodiment, the small molecule is a non-rigid molecule.

Some examples of small molecules may be found in U.S. patent application Ser. No. 13/265,568, filed Oct. 21, 2011, the entire contents of which are hereby incorporated by reference.

Molecular dynamics and Monte Carlo simulations are well-known. So long as multiple conformations of the large and small molecule can be obtained therefrom, the choice of MD and Monte Carlo simulation is not particularly limited. Some examples of MD simulations, which are not intended to be limiting, include CHARMM (“Chemistry at Harvard for Molecular Mechanics”) molecular simulation program; SILCS (“Site Identification by Ligand Competitive Saturation”) simulations, GROMACS (GROningen MAchine for Chemical Simulations (http://www.gromacs.org/)), OpenMM (https://simtk.org/home/openmm), and combinations thereof. For convenience, the terms, “simulation” or “simulations” are suitably used as shorthand for either molecular dynamics simulation or Monte Carlo simulation. In one embodiment, a CHARMM or SILCS simulation is used. In one embodiment, a Monte Carlo simulation is used.

Though not required, one or more additional modules may be added to or used in conjunction with the MD or Monte Carlo simulations, as known in the art. Non-limiting examples include those relating to one or more of force field; correction map; water modeling; general force field; choice and optimization of side chain or ring; addition, deletion, or retention of hydrogen, water molecules, non-crystallographic water molecules, ions, positive counterions, negative counterions, and the like; topology, charge, and/or initial guess parameters; and any combination of the foregoing. Non-limiting examples of such modules include CMAP (“Correction Map”), TIP3P water model, CHARMM general force field (CGenFF), PDB (“Protein Data Bank”), Reduce, and the like, or any combination thereof. Any of these may be suitably applied to the system (for example, including the small molecule, large molecule, binding environment), or any of the small molecule, large molecule, binding environment, and/or modified small molecule alone or in any combination.

Though not required, one or more other modules may be added or used in conjunction with the MD simulation, as known in the art. Non-limiting examples include those relating to periodic boundary conditions, integrators, time steps, water and/or ligand geometries and/or bonds, electrostatic and other interactions, switching functions, energy, pressure, temperature, number of particles, n, positional restraints, weak restraints, isotropic correction, velocity reassignment, ligand rotation, descent algorithm, force constant, and the like. Any of these may be suitably applied to the system (for example, including the small molecule, large molecule, binding environment), or any of the small molecule, large molecule, binding environment, and/or modified small molecule alone or in any combination.

The number of steps is not particularly limited, and the simulation may be carried out with any suitable number. For example, 100 to 10,000 steps may be used. This range includes all values and subranges therebetween, including 100, 200, 300, 400, 500, 600, 700, 800, 900, 1000, 1250, 1500, 1750, 2000, 2500, 5000, 7500, 10,000 steps, or any combination thereof. Numbers of steps outside the aforementioned range may also be used if desired.

The force constant is not particularly limited, and the simulation may be carried out with any suitable number. For example, a range of 0.01 to 10 kcal*mol⁻¹Å⁻² per atomic mass unit on ligand non-hydrogen atoms may be suitably used. This range includes all values and subranges therebetween, including 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10 kcal*mol⁻¹Å⁻² per atomic mass unit on ligand non-hydrogen atoms, or any combination thereof. Force constants outside the aforementioned range may also be used if desired.

The time step is not particularly limited, and the simulation may be carried out using any suitable number of time steps. For example, a time step range of 0.1 to 200 fs may be suitably used. This range includes all values and subranges therebetween, including 0.1, 0.2, 0.3, 0.4, 0.5, 0.6, 0.7, 0.8, 0.9, 1, 2, 3, 4, 5, 6, 7, 8, 9, 10, 15, 20, 25, 50, 75, 100, 110, 125, 150, 175, 200 fs, or any combination thereof. Time steps outside the aforementioned range may also be used if desired.

Interaction distances, cutoff distances, and the like are not particularly limited, and the simulation may be carried out using any suitable distance independent of other distances. For example, interaction and/or cutoff distances independently ranging from 0.1 to 50 Å may be suitably used. This range includes all values and subranges therebetween, including 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 35, 40, 45, 50 Å, or any combination thereof. Distances outside the aforementioned range may also be used if desired.

The frequency of snapshots output for analysis is not particularly limited, and any suitable number may be used. For example, the number of snapshots output may suitably range from 0.to 20 ps. This range includes all values and subranges therebetween, including 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20 ps, or any combination thereof. In one embodiment, snapshots may be output every 2 ps for analysis for the MD simulations. Frequencies outside the aforementioned range may also be used if desired.

Temperature and pressure are not particularly limited, and any suitable values may be used. Typically, temperature and pressure are maintained at 298 K and 1 atm over all simulations and calculations using known methods, but other temperatures and pressures may be used if desired.

In one embodiment, long-range electrostatic interactions may be handled with the particle-mesh Ewald method. In one embodiment, a real space cutoff ranging from 1 to 20 Å may be used. This range includes all values and subranges therebetween, including 1, 2, 3, 4, 5, 6, 7, 8, 9, 10, 12, 14, 16, 18, 20 Å or any combination thereof.

In one embodiment, wherein SILCS simulations are used, it may be desirable to obtain a larger number of trajectories, and the snapshot output frequency may be adjusted accordingly.

In one embodiment, solvated orthorhombic periodic systems may be generated by overlaying the crystal coordinates of the small molecule with a pre-equilibrated water box the dimensions of which are 10 Å longer than the maximum dimensions of the large molecule along each of the three orthogonal axes. Other dimensions are possible, including 1, 2, 3, 4, 5, 6, 7, 8, 9, 10, 11, 12, 15, 16, 18, 20 Å, or any combination thereof, longer than the maximum dimensions of the large molecule along one or more, or each of the three orthogonal axes.

In one embodiment, it may be desirable to delete one or more, or all of the non-crystallographic water molecules having any atom within 1, 2, 3, 4, 5, 6, 7, 8, 9, or 10 Å of any atom of the large molecule.

If desired, a net system charge may be made neutral by replacing random water molecules with the appropriate number of positive or negative counterions, e.g., sodium or chloride ions.

In one embodiment, the small molecule has a lower molecular weight than the large molecule.

In one embodiment, a solvation free energy of the modified small molecule may be obtained using a simulation of the unmodified small molecule in a water box. The water box may have any suitable dimensions. In one embodiment, the molecule may be restrained to the center of the box using an appropriate center of mass restraint.

In one embodiment, wherein a SILCS simulation is carried out, small molecule atoms within 1, 2, 3, 4, 5, 6, 7, 8, 9, 10, 11, 12, 13, 14, 15, 16, 17, 18, 19 or 20 Å from any large molecule atom may be binned into a 3D grid or “FragMap” composed of 1 Å×1 Å×1 Å volume elements. The size of the volume elements is not particularly limited, and may suitably range from (1 Å)³ to (10 Å)³, or any value therebetween. In one embodiment, the FragMap probability grid may be Boltzmann transformed into the grid free energy (GFE) in accordance with known methods. The centers of grid elements having a GFE value below a threshold may be clustered to identify binding sites of the small molecule on the large molecule surface using the following algorithm. An arbitrarily chosen grid center point may be assigned to the first cluster and thereafter, each grid element may be either assigned to an existing cluster if its center is located closer in Euclidian space than that cluster's radius value to that cluster, or a new cluster is created otherwise. The cluster radius value is not particularly limited, and may suitably range from 1-50 Å, for example. This range includes all values and subranges therebetween, including 1, 2, 3, 4, 5, 6, 7, 8, 9, 10, 15, 20, 25, 30, 35,40, or 50 Å, or any combination thereof. After the inclusion of each element in a cluster, the cluster center may be recomputed as the mean of the coordinates of the members. Following the initial assignment, an iterative loop may be run, which can redo the cluster assignment based on the distance from existing cluster centers. The iteration may be terminated once no more updates of the cluster assignment occur. In one embodiment, the clusters are obtained using an affinity map generated with SILCS.

In one embodiment, a cluster may be defined by a binding site on the large molecule, and, depending on the size of the binding site relative to the size of the small molecule, one or more than one clusters may be present in a binding site.

In one embodiment, a cluster may be distinguished from an unphysical reference state for the small molecule such as described, for example, by van Gunsteren and others.

In one embodiment, one or more clusters are determined, and then snapshots are obtained of the multiple conformations of the small and large molecule in a cluster. The small molecule energies, e.g., and E_{L1} and E_{L2}, are calculated for a single snapshot using Eq. (2) described further below and are a function at least in part of a single conformation of the small and large molecule in a binding environment and the force field that the small molecule is experiencing, according to known methods.

In one embodiment, referring to Eq. (1) described further below, the term, [symbol] exp^{-(E}^{_{L2}}^{-E}^{_{L1}}^{)/RT} [symbol] _{L1} is averaged over all the snapshots of the multiple conformations of a small molecule L1 and the large molecule in a cluster or binding environment.

In one embodiment, a binding environment is or includes a region where binding occurs between the small and large molecule, a vacuum, a solvent, water, a site on the large molecule (e.g., a protein pocket), a cluster, or any combination thereof. In one embodiment, a binding environment of the large molecule may be an area within a range of suitably chosen distances from any atom on the surface of the large molecule. The distance is not particularly limited, and may suitably range from 1 to 20 Å from any atom on the surface of the large molecule. This range includes all values and subranges therebetween, including 1, 2, 3, 4, 5, 6, 7, 8, 9, 10, 11, 12, 13, 14, 15, 16, 17, 18, 19 or 20 Å, or any combination thereof. In one embodiment, the binding environment may include an area that does not extend beyond a certain maximum distance from the large molecule surface, yet does not come within a certain minimum distance of the large molecule surface. These maximum and minimum distances may be easily determined and defined according to known methods.

In one embodiment, replacing one or more atoms of the small molecule with one or more different atoms for each of the conformations, to obtain a modified small molecule in the binding environment, includes aligning (sometimes referred to as overlaying) the modified small molecule (having the atoms so replaced) with the small molecule for each of the single conformations in the multiple conformations.

In one embodiment, the energy of the small molecules in the binding environment for the multiple conformations, and also the energy of the modified small molecules in the binding environment for the multiple conformations, e.g., E_{L1} and E_{L2}, may he obtained using CHARMM, GROMACS, OpenMM, and the like. It may be desirable to modify the CHARMM, GROMACS and OpenMM programs using a script using MDAnalysis, VMD, and the like. Here, at least for determining the energy of the modified small molecule in the binding environment, the energy determination is distinct from the molecular dynamics aspects of the aforementioned programs and scripts.

In one embodiment, the estimated difference between binding free energies is an estimation of the values obtained experimentally, e.g., using physical methods.

In one embodiment, the estimated difference between binding free energies of the small and modified small molecules achieves a predictive index, P1, determined using Eqn. (6) described in the examples, between experimentally obtained and computed values, is greater than 0. This range includes all values and subranges therebetween, including 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, and 1, or any combination thereof. In one embodiment, the PI is 0.51 or more.

One or more of the embodiments disclosed herein may be encoded as a computer program (also referred to as computer software, software applications, computer-readable instructions, or computer control logic) on a computer-readable medium.

The phrase “computer-readable medium” generally refers to any form of device, carrier, or medium capable of storing or carrying computer-readable instructions. Examples of computer-readable media include, without limitation, transmission-type media, such as carrier waves, and physical media, such as magnetic-storage media (e.g., hard disk drives and floppy disks), optical-storage media (e.g., CD- or DVD-ROMs), electronic-storage media (e.g., solid-state drives and flash media), network-attached storage (NAS) device, and other distribution system.

The computer-readable medium containing the computer program may be loaded into a computing system. Examples of computer systems include, without limitation, an application specific integrated circuit (ASIC) adapted to implement one or more of the embodiments disclosed herein; desktop or laptop computer, handheld device, or client system coupled to a network, application server, or database server, or the like. The computer system desirably includes one or more of a viewing screen, keyboard, touch screen, mouse, voice activated device, and the like.

All or a portion of the computer program stored on the computer-readable medium may be stored in a system memory and/or various portions of one or more storage devices. When executed by a processor, a computer program loaded into the computing system may cause the processor to perform the functions of one or more of the embodiments described herein. Additionally or alternatively, one or more of the embodiments described herein may be implemented in firmware and/or hardware.

Communication between one or more of the computer user, computer-readable medium, computer system, storage device, network, processor, and the like may be carried out in accordance with known methods, including, without limitation, telecommunication, wired communication, computer network, intranet, wide area network (WAN), local area network (LAN), personal area network (PAN), or the Internet.

### EXAMPLES

A further understanding can be obtained by reference to certain specific examples, which are provided herein for purposes of illustration only and are not intended to be limiting unless otherwise specified.

Methods

MD Simulations

In the examples described, all simulations were performed using the CHARMM molecular simulation program, the CHARMM protein force field with CMAP (“Correction Map”) backbone correction, and the TIP3P water model. The CHARMM general force field (CGenFF) version 2b5 was used for all ligands. The CGenFF program version 0.9.1 beta (accessible through the ParamChem interface) was used to obtain the topology, charges and initial guess parameters for the two parent inhibitors of thrombin and P38MK containing the unsubstituted phenyl group. These initial parameters were further optimized and validated per the CGenFF procedure which uses quantum mechanical (“QM”) energies and geometries as target data. For simulations involving proteins, any crystal water molecules present in the PDB (“Protein Data Bank”) coordinates were retained, as were any structurally important ions. The Reduce software was used to choose optimal Asn and Gln side chain amide and His side chain ring orientations and CHARMM was used to add hydrogen atoms. Solvated orthorhombic periodic systems were generated by overlaying the crystal coordinates of the protein with a pre-equilibrated water box the dimensions of which were 10 Å longer than the maximum dimensions of the protein along each of the three orthogonal axes. All non-crystallographic water molecules with any atom within 2 Å of any protein atom were deleted. The net system charge was made neutral by replacing random water molecules with the appropriate number of sodium or chloride ions. For thrombin, the missing residues of the protein were built and the protocol for protein preparation was slightly different and it involved the deletion of crystal waters also based on the 2 Å cutoff as detailed in our previous work. The present setup of the SILCS simulations is very similar to that reported in detail previously. To obtain the solvation free energy of benzene analogues, a 10 ns simulation of benzene in a water box of dimensions 32 Å×32 Å×32 Å was performed with the benzene molecule restrained to the center of the box using a center of mass restraint of 0.5 kcal*mol⁻¹Å⁻².

Unless otherwise mentioned, all systems in the presence of periodic boundary conditions were minimized for 500 steps with the steepest descent algorithm while employing harmonic positional restraints with a force constant of 1 kcal*mol⁻¹Å⁻² per atomic mass unit on protein non-hydrogen atoms. The leapfrog variant of the Verlet integrator with a time step of 2 fs was used for molecular dynamics (MD) simulations. Water geometries and bonds involving hydrogen atoms were constrained using the known SHAKE algorithm. Long-range electrostatic interactions were handled with the particle-mesh Ewald method with a real space cutoff of 8 Å. A switching function was applied to the Lennard-Jones interactions in the range of 5 to 8 Å, and a long-range isotropic correction was applied to the energy and pressure for Lennard-Jones interactions beyond the cutoff length. Following minimization the system was heated with the same positional restraints over 10 ps to 298 K by periodic reassignment of velocities, followed by an equilibration for 10 ps using velocity reassignment. In the production simulations that followed, unless otherwise indicated, the positional restraints were replaced by weak restraints on only the protein backbone Ca atoms with a force constant of 0.01 kcal*mol⁻¹Å⁻² per atomic mass unit to prevent the rotation of the protein in the simulation box. Temperature and pressure were maintained at 298 K and 1 atm with a Nosé-Hoover thermostat and Langevin piston barostat, respectively. Snapshots were output every 2 ps for analysis for the protein-ligand MD simulations. For the SILCS simulations, a larger number of trajectories was obtained and the snapshot output frequency was 5 ps. For the benzene+water system, a force-switching function was applied to the Lennard-Jones interactions in the range of 10 to 12 Å and the real space cutoff for PME (“Particle Mesh Ewald”) electrostatics was 12 Å. The system was minimized for 5000 steps with the steepest descent algorithm while employing harmonic positional restraints with a force constant of 1 kcal*mol⁻¹Å⁻²on benzene atoms. Following minimization the system was equilibrated with the same positional restraints for 1 ns using velocity reassignment followed by a 10 ns production simulation in the NPT (“constant n, pressure, and temperature”) ensemble with snapshots output for analysis every 2 ps.

Identification of Benzene Binding Sites

From the SILCS simulation data of α-thrombin, benzene carbon atoms less than 5 Å from any protein atom were binned into a 3D grid or “FragMap” composed of 1 Å×1 Å×1 Å volume elements and the FragMap probability grid was Boltzmann transformed into the grid free energy (GFE). The centers of grid elements having a GFE value lower than −1.2 kcal/mol were clustered to identify binding sites of benzene on the protein surface using the following algorithm. An arbitrarily chosen grid center point was assigned to the first cluster and thereafter, each grid element was either assigned to an existing cluster if its center was located closer in Euclidian space than the cluster radius value of 5 Å to that cluster or a new cluster was created otherwise. After the inclusion of each element in a cluster, the cluster center was recomputed as the mean of the coordinates of the members. Following the initial assignment, an iterative loop was run, which would redo the cluster assignment based on the distance from the existing cluster centers. The iteration was terminated once no more updates of the cluster assignment occurred; typically only one or two iterations were required.

Single Step Perturbation Calculations

The alchemical free energy difference of transforming a ligand L1 to L2 in environment E for each of the sites identified using the clustering algorithm is computed per the perturbation formula as follows:

ΔG_{L1→L2}^{E}=−RT ln [symbol] exp^{-(E}^{_{L2}}^{-E}^{_{L1}}^{)/RT} [symbol] _{L1} (1)

where RT (=0.592 kcal/mol) is the product of the ideal gas constant and the absolute temperature and E_{L1} and E_{L2} are the ligand energies. The average is computed over the ensemble of conformations obtained from the simulation of ligand L1 in environment E. The energy of a ligand X and its environment is decomposed into the following terms:

E_{X}=E_{XX}+E_{XE}+E_{EE} (2)

where E_{XE} is the nonbonded interaction energy between ligand X and environment E and E_{XX} is the internal energy of ligand X. The self-energy of the environment E_{EE} cancels when computing the energy difference between two ligands as the precalculated ensemble of conformations of the protein and solution from the SILCS simulations are identical. The relative solvation and binding free energies computed in this work are given as follows in Eqns 3 and 4 respectively:

ΔΔG_{L1→L2}^{solv}=ΔG_{L1→L2}^{water}−ΔG_{L1→L2}^{vacuum} (3)

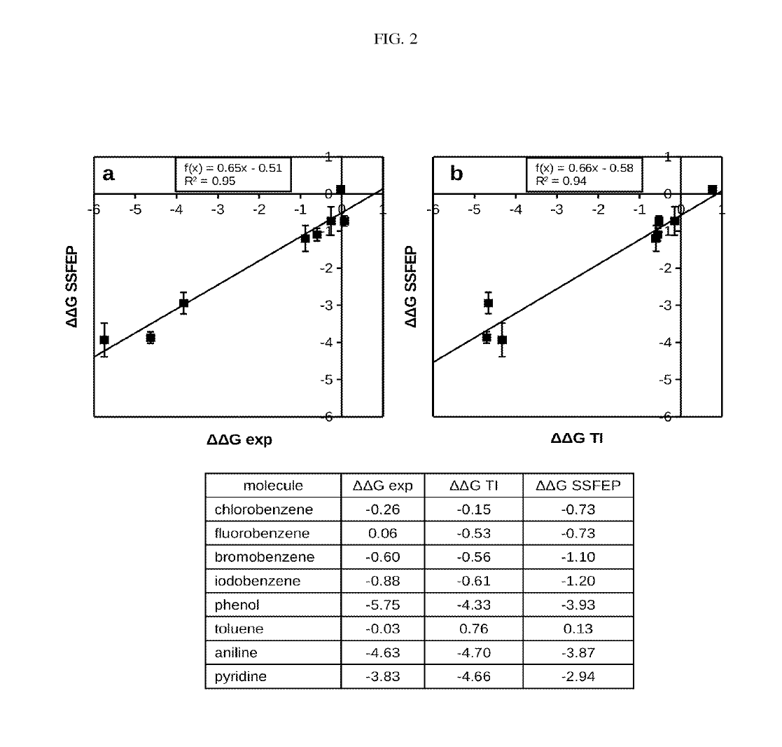

ΔΔG_{L1→L2}^{bind}=ΔG_{L1→L2}^{protein}−ΔG_{L1→L2}^{water} (4)

Where, ΔΔG_{L1→L2}^{E} is the alchemical free energy difference computed in environment E per Equation 1. In the present examples, L1 is always benzene and L2 is one of the 8 monosubstituted benzene analogues (FIG. 2, below). The test set included several ligands in which the phenyl ring could assume two possible orientations in the binding pocket due to the rotation about the bond linking the phenyl ring to the rest of the ligand. Since the SSFEP calculations do not allow for rotation of the phenyl ring, the relative free energies of binding were combined using the following equation.

ΔΔG=−RT ln └exp^{-ΔΔG}^{_{O1}}^{^{bind}}^{/RT}+exp^{-ΔΔG}^{_{O2}}^{^{bind}}^{/RT}┘+RT ln 2 (5)

Where the subscripts O1 and O2 indicate the two different ring orientations. For the ligands in the test set that involved two substitutions on the phenyl ring, the free energy difference was obtained by summing the relative free energies computed for the individual single substitution analogues. This is an approximation because the contributions are not additive, but its utility is demonstrated by the observation that it reproduces the experimental trend, consistent with previous studies.

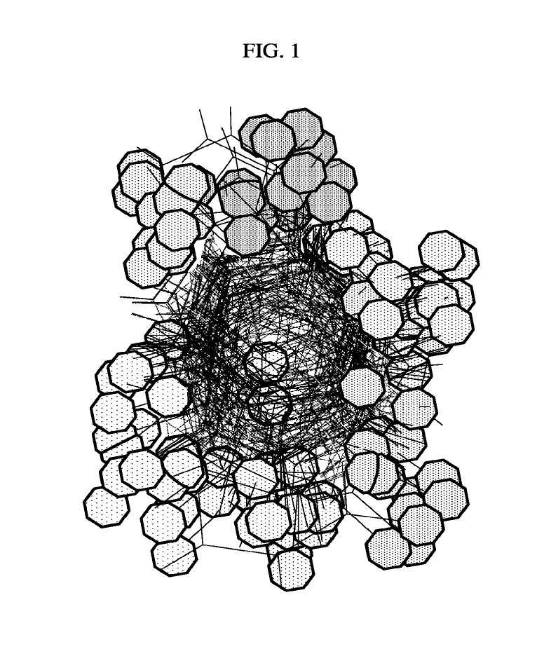

Simulations to evaluate the free energy difference between benzene and its analogues using SSFEP were set up and carried out as follows. In order to mimic the phenyl ring on a larger inhibitor in the anisotropic protein environment, it is necessary to distinguish the 6 possible substitution positions on a benzene ring. This was accomplished by first choosing a reference conformation of benzene in the environment. In the case of the two studied proteins, results are reported with the reference conformation being the crystal conformation of the phenyl ring of the corresponding parent inhibitor (ATI and MKI). In the results section, it is shown the choice of reference conformation does not influence the results significantly. For each snapshot, the rotation of the benzene ring was neglected and the carbon atoms were renamed (without altering the coordinates themselves) so as to have the minimum possible RMSD (“Root-mean square difference”) with respect to the reference conformation, where the RMSD is sensitive to the label of each carbon atom. This results in orientation #1 of the substituted benzene, which is “aligned” to the reference conformation. The 5 additional orientations (i.e. with the substituent at positions 2 through 6) are subsequently generated resulting in a total of 6 orientations for each snapshot. This approach is necessary because if a given position (e.g. position 1) of the benzene ring was assigned a new atom type at the beginning of the trajectory and maintained throughout the trajectory, it is highly likely that the benzene ring would rotate such that position 1 on the ring would now occupy the location on the protein surface previously occupied by one of the other 5 positions, which cannot occur with a phenyl group that is part of a larger hound ligand. It is worth restating that the coordinates are not in any way altered in generating these orientations, only the label of each atom is changed so that in the subsequent alignment step the six possible orientations obtained. Only the ring carbon atoms are considered in the RMSD computation. Following this step, the precomputed energy-minimized conformations of the respective benzene analogs are aligned to the benzene conformation from the SILCS simulation or from the protein-ligand simulation. For aniline, the planar nitrogen conformation was chosen instead of the slightly pyramidized conformation (which is slightly more stable). FIG. 1 illustrates the alignment procedure by displaying the generated conformations of fluorobenzene from the analysis of the benzene conformational distribution obtained from the SILCS simulations of α-thrombin. The 20 most favorable conformations in each of the six orientations of the ligand are depicted with the fluorine substituent colored differently in each orientation. As expected, a broad distribution of the substituents is observed, which is centered approximately at the six substitution positions on the phenyl ring and partially overlaps with the neighboring substituent distributions. In the case of phenol, two different conformations that differ in the position of the alcohol hydrogen atom were generated for each of the 6 orientations, resulting in 12 geometries to be evaluated. By using previously energy-minimized analogues, one does not consider contributions from slight deviations from planarity of the benzene observed in MD simulations to the calculated free energy differences. Without wishing to be bound by theory, it is assumed that contributions from such minor deformations cancel out when calculating free energy differences.

All energy computations on the composite ligand-environment snapshots were performed using an in-house post-processing routine involving CHARMM. The nonbonded interaction energy between the ligand and the environment was computed with a cutoff of 29 Å. In the range of 28 to 29 Å, a force-switching function was applied to the electrostatic and the Lennard-Jones interactions. Periodic images were re-built in the post-processing routine and were included in the calculations. Other than the explicit calculation of the pairwise non-bonded interactions, long range electrostatic or Lennard-Jones correction terms were not considered. This treatment of the nonbond interactions was applied for all the SSFEP energy calculations although the truncation schemes in the MD simulations to generate the ensembles in protein and in solution were different (see above). As a check, a second set of simulations of benzene in water was performed that used the same non-bonded truncation scheme as in the protein simulations, and no significant difference was found in the free energy values (data not shown).

Thermodynamic Integration Calculations

Thermodynamic Integration (TI) calculations were performed using the PERT (“Perturbation”) module in CHARMM to obtain the relative hydration free energies of benzene analogues in order to check for any dependence of the results on the force field. The system setup for the alchemical transformation in solution involved the same dynamics parameters as used for the benzene-water MD simulation described above. For each transformation, both forward and backward perturbations were performed using 22 λ-windows, each being 100 ps long including a 50 ps equilibration period. All solute and water bonds were held fixed using the SHAKE algorithm. Transformations in vacuum were performed with infinite nonbonded cutoffs and involved 22 λ-windows, each being 20 ps long including a 4 ps equilibration period.

Analysis

Computed ΔΔG values are compared with experimental values using correlation plots and computing R² values of linear regression. In order to quantify the ability of the method to rank order ligands by binding free energy, the Predictive Index (PI) metric developed by Pearlman and Charifson is used, as shown in Eq. (6).

$$PI = \frac{{\sum }_{j > i} {\sum }_{i} {w}_{ij} {C}_{ij}}{{\sum }_{j > i} {\sum }_{i} {w}_{ij}} \\ {w}_{ij} = \vert E ( j ) - E ( i ) \vert \\ {C}_{ij} = \{ \begin{matrix}- 1 if [ E ( j ) - E ( i ) ] \text{/} [ P ( j ) - P ( i ) ] < 0 \\ 1 if [ E ( j ) - E ( i ) ] \text{/} [ P ( j ) - P ( i ) ] > 0 \\ 0 if [ P ( j ) - P ( i ) ] = 0\end{matrix} \qquad ( 6 )$$

where E(i) and P(i) are the experimental and computed values of relative free energies of data point i, respectively. By definition PI can assume values between −1 and 1. A value of 1 implies all data points were ranked correctly pairwise, −1 implies all pairs were incorrectly ranked and 0 implies totally random predictions.

Results

To validate the presented method, three systems were selected. The first dataset involves the relative hydration free energy of benzene analogues. To investigate the approach in the presence of a protein, two systems were selected; α-thrombin and P38 MAP kinase (P38MK) for which relative free energies have been measured for a large set of compounds (14 and 16, respectively) that involve single and double phenyl ring substitutions. The choice of full drug-sized molecules that incorporate the fragment is made keeping in mind the ultimate use of the protocol, which is to link the modified fragments into drug-sized molecules. In addition, the choice of model systems is limited due to the lack of a large dataset of experimental values for benzene analogs themselves. The only case to our knowledge where experimental data is available for individual substituted benzenes is that of T4-Lysozyme. Unfortunately, only a few ligands in these studies feature a single heavy atom substitution, for which our protocol is designed so that the useable fraction of the T4-Lysozyme dataset is too small for our purpose. It should be emphasized that in the present study, the relative binding free energy calculations are made separately for each of the six positions on benzene. This allows for direct comparison with the specific substitutions on the phenyl ring on the drug-like molecules, where reorientation of the benzene is restricted due to its connectivity to the remainder of the compound.

Relative Solvation Free Energies of Benzene Derivatives

A 10 ns production MD simulation of a single benzene molecule in a cubic box of 1100 water molecules was performed. The SSFEP protocol was then applied to the resulting 5000 snapshots and the relative solvation free energy ΔΔG_{benzene→analogue}^{solv} of 8 benzene analogues computed using equations 1-3. Even though benzene is in an isotropic environment in the present system, the six possible transformations were generated for each analogue and ΔΔG_{benzene→analogue}^{solv} were computed separately for each transformation in order to check the convergence of the results. FIG. 2a shows predicted values ±1 standard deviation averaged over the 6 substitutions vs. the experimental data. A high R² value of 0.95 and a PI of 0.99 shows that the experimental trend is reproduced. The small error bars in the figure also show that the values computed separately for each orientation are in reasonable agreement with each other and therefore show that the 10 ns simulation is satisfactory to obtain converged free energies. Relative solvation free energies for the polar compounds are underestimated, but nevertheless the trend in the relative values is captured. TI calculations to compute solvation free energy were performed to check for any force-field dependence in the results. An average of the TI calculation performed in the forward and negative of the value in backward direction was evaluated to yield the TI relative free energy. Figure S1a in the supporting information shows a satisfactory level of agreement between the forward and the backward direction calculations in vacuum and in solution. FIG. 2b shows the SSFEP computed values vs. those computed using TI. Tabulated values of the three data sets show that some of the deviations from the experimental values are due to the force field but most are not. In general, the SSFEP calculations predict the hydration free energies of non-polar analogues to be more favorable than experiment. For fluorobenzene, the TI calculations also predict more favorable free energy. However, for chloro-, bromo- and iodobenzene, the TI calculations do not overestimate the free energy as the SSFEP calculations do. For the polar molecules phenol and aniline, the TI values better match the experiment, whereas for pyridine and toluene this trend is not observed. Figure S1b in the supporting information plots the TI computed free energies vs. experiment. While the R² of 0.91 and PI of 0.91 are slightly lower than those obtained from SSFEP calculations, the slope of the regression line at 0.93 is closer to 1 than obtained from the SSFEP results at 0.65, showing that the systematic underestimation of polar and overestimation of non-polar compound free energies in SSFEP is not present in TI results. Overall, the TI calculations better reproduce the experimental data, but the SSFEP calculations also show reasonable correlation with the latter. Having observed a close correspondence between TI and experimental results, further TI calculations for the binding free energies were deemed unnecessary.

Relative Binding Free Energies of α-Thrombin Ligands

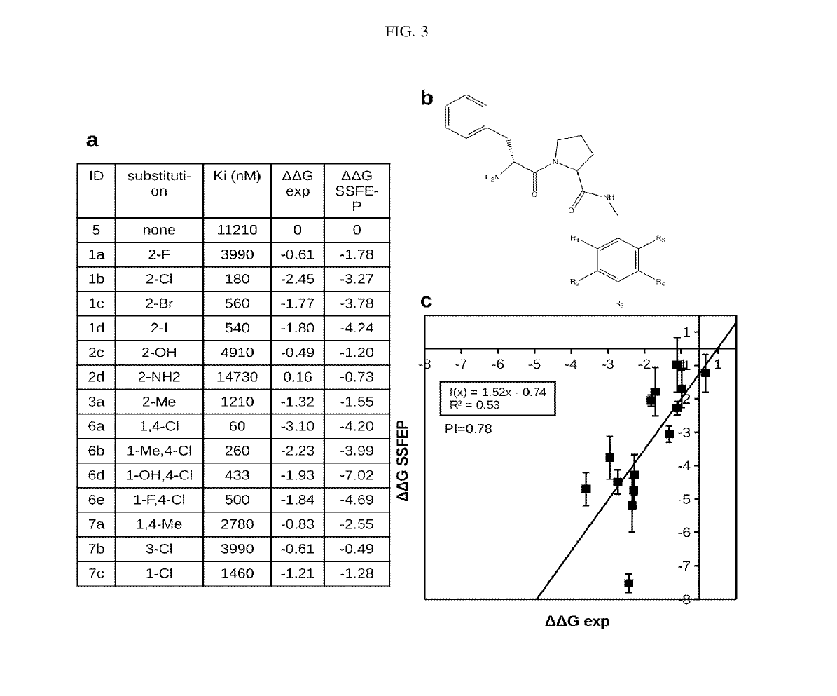

As a first test case for the prediction of relative binding free energies of a series of substituted phenyl rings using the SSFEP method, the protein α-thrombin was chosen. Baum et al. have measured the binding affinities of a congeneric series of thrombin inhibitors, which differ mainly in substitutions on the phenyl ring that occupies the specificity pocket of the protein. 14 ligands that have one or more single heavy atom substitutions on the phenyl ring of the inhibitor were chosen and these are shown in FIGS. 3a and b, along with the parent ligand (compound 5), referred to as ATI, short for α-thrombin inhibitor. For each analogue, ΔG^{bind} was calculated as RT ln Kᵢ and the ΔG^{bind} of the unsubstituted compound was subtracted from this value in order to obtain the experimental ΔΔG_{benzene→analogue}^{bind}. There can be two possible conformations that the substituted phenyl ring may occupy in the binding pocket for many of these ligands. For example, for ligand 1a, the fluorine substitutions on positions R2 and R4 are equivalent. However, since the SSFEP calculations separate out the free energy values at distinct substitution positions and conversions between these alternate conformations cannot occur, the contributions from two orientations are combined using equation 5.

The ensemble of benzene conformations on which SSFEP calculations were performed was obtained from two independent 10 ns simulations of ATI in the binding pocket of thrombin. The apo-structure of thrombin (PDB 3D49) was used in all calculations reported in this paper. The initial conformation of ATI was obtained from the crystal structure (PDB 2ZFF) of the thrombin-ATI complex and was overlaid with the apo structure of the protein (PDB 3D49) based on optimal alignment of the protein conformations followed by the deletion of overlapping crystallographic water molecules using a 2 Å cutoff. Two 10 ns NPT MD simulations of the complex resulted in 5000×2 conformations of the phenyl ring that were extracted from the MD snapshots and these were subject to the SSFEP protocol. The initial phenyl ring conformation in ATI was chosen as a reference and the 6 possible transformations were generated for each snapshot. These transformations could thus be mapped to the ligands for which experimental data is available. It must be noted that the SSFEP energy evaluations were performed with only the benzene ring and not the whole ligand. Therefore the same protocol was applied to calculate the free energy differences associated with the benzene substitutions when the ensemble of benzene orientations is generated from a simulation of the full inhibitor-protein complex or from SILCS simulations (see below). This includes removal of rotation of the ring based on optimal alignment of ring atoms with the reference conformation. Due to the phenyl ring being attached to the rest of the ligand, this rotation is minimal for the inhibitor-protein complex simulation and results in nearly identical predictions with or without the rotation removal (see below). The cumulative 20 ns sampling was divided into four 5 ns segments and SSFEP calculations were performed separately on the four ensembles. Averages of the resulting values vs. the experimental binding free energies are listed in FIG. 3a and plotted in FIG. 3c for the 14 ligands, where the length of the error bars is equal to twice the standard deviation of the four values. Overall, the experimental trend is well reproduced with a reasonable correlation (R²=0.53). Predictive index computed per equation 6 is 0.78, which indicates good rank ordering ability of the method in accordance with experimental binding free energy. Compound 6d, which has a double Cl and OH substitution, is an outlier. Removal of this compound from the dataset causes the R² and PI values to improve to 0.67 and 0.80, respectively. Figure S2a in the supporting information shows the nearly identical results obtained without removal of rotation, as expected given the constrained orientation of the phenyl ring due to the remainder of the ligand.

Relative Binding Free Energies of p38-MAP Kinase (P38MK) Ligands

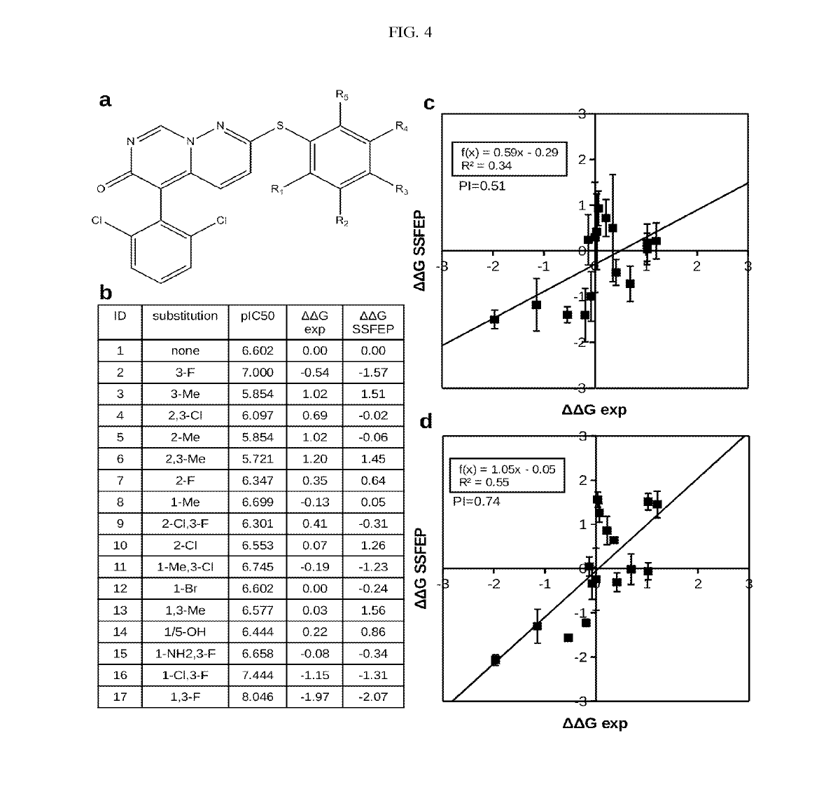

In a second test case for the prediction of relative binding free energies, a set of 16 p38 MAP kinase inhibitors were chosen from a congeneric series for which experimental pIC₅₀ data are available. In this system, two sets of simulations were performed from which the SSFEP free energy estimates were made. In the first only the C restraints on the protein were included, as with -thrombin, and in the second, larger harmonic restraints on all protein atoms were included. FIGS. 4a and b show the parent inhibitor, referred to as MKI (short for MAP kinase inhibitor), and the list of modifications that differ by substitutions on a phenyl ring (R1 to R5). The experimental ΔΔG_{benzene→analogue}^{bind} for each analogue was computed by taking the difference between RT ln 10^{-pIC50} values computed for the substituted and unsubstituted analogue. As with thrombin, there exist contributions to free energy from multiple possible orientations that the phenyl ring can assume in the binding pocket and therefore, equation 5 was used to compute the SSFEP free energy values corresponding to those ligands. Following the same protocol as for thrombin, two independent 10 ns MD simulations of MKI in complex with P38MK were performed. The initial coordinates were obtained from the co-crystal structure of the protein in complex with a very similar inhibitor (PDB 1OUY). The phenyl ring conformation in the crystal structure was used as the reference conformation for generating the 6 possible transformations for the benzene analogues. FIG. 4c displays SSFEP predictions averaged over the 4 5 ns windows vs. experimental values of the relative binding free energies of the ligand computed from the protein-unrestrained simulation. Poor correlation is observed with respect to the experimental values; however a PI of 0.51, lower than obtained with thrombin, still shows that satisfactory rank ordering is obtained.

Two previous computational studies have sought to reproduce the P38MK experimental data as a test of the accuracy of thermodynamic integration calculations. Results from those studies highlight difficulties faced in calculating relative free energies in this system, even by highly precise methods. Pearlman and Charifson performed thermodynamic integration calculations to reproduce the relative binding free energies of the same set of ligands and found poor predictability due to the protein pocket being very flexible. They could only get a reasonable prediction when using a harmonic restraint of 0.5 kcal*mol⁻¹Å⁻² on protein atoms. Accordingly, following their approach, a second set of simulations referred to as the “restrained” simulation was carried out in which restraints of 0.5 kcal*mol⁻¹Å⁻² were applied to all protein atoms. FIG. 4b lists the predicted values from the restrained simulation and FIG. 4d plots them vs. experimental data. The correlation with experimental data is improved over that of the initial simulation predictions, and the PI value has increased to 0.74. Additionally, the variance in the calculated values also is seen to be higher in the predicted values from the unrestrained simulation, confirming that the flexibility of this pocket may indeed be the cause of the relatively poor predictability. These results are in line with the previously published study on this protein indicating it to be a particularly difficult challenge due to its inherent flexibility.

As with thrombin, an ensemble of benzene conformations was generated from the inhibitor-protein simulation, with the removal of rotation of the phenyl ring not performed. Figure S2b in the supporting information shows the results obtained without this modification for the protein-restrained simulation. A relatively worse correspondence with the experimental data is obtained with a PI of 0.53, indicating the importance of rotation removal in this protein, which appears to be associated with the flexibility issues discussed above.

In addition, as done previously, it is noted that the conversion of pIC₅₀ values into ΔG is approximate as opposed to conversion from Kᵢ values, which is another potential source of error. The PI values obtained for the same dataset using two studies that involved precise TI calculations were 0.62 and 0.84, indicating that the results obtained using the rapid SSFEP protocol are reasonable.

Application of the SSFEP Protocol to SILCS Simulation Data of Thrombin

The present inventors have shown that by applying the SSFEP protocol on the phenyl ring snapshots generated from MD simulations of protein-ligand complexes it is possible to reproduce the experimental relative binding free energy values of simple substitutions of the ring. In this section, an approach is applied that extracts conformations from SILCS simulation trajectories and applies the SSFEP protocol to the resultant ensemble. SILCS simulations involve MD simulations of a protein in aqueous solution of small molecule fragments. The present inventors have recently reported SILCS simulations of thrombin in a solution of benzene and propane molecules in which the benzene FragMaps correctly located the S1-specificity pocket where the phenyl group of the α-thrombin inhibitor ATI is located. This suggested the possibility that the ensemble of benzene generated from the SILCS simulations itself may he of utility in combination with SSFEP calculations to predict the relative binding of the ATI analogs.

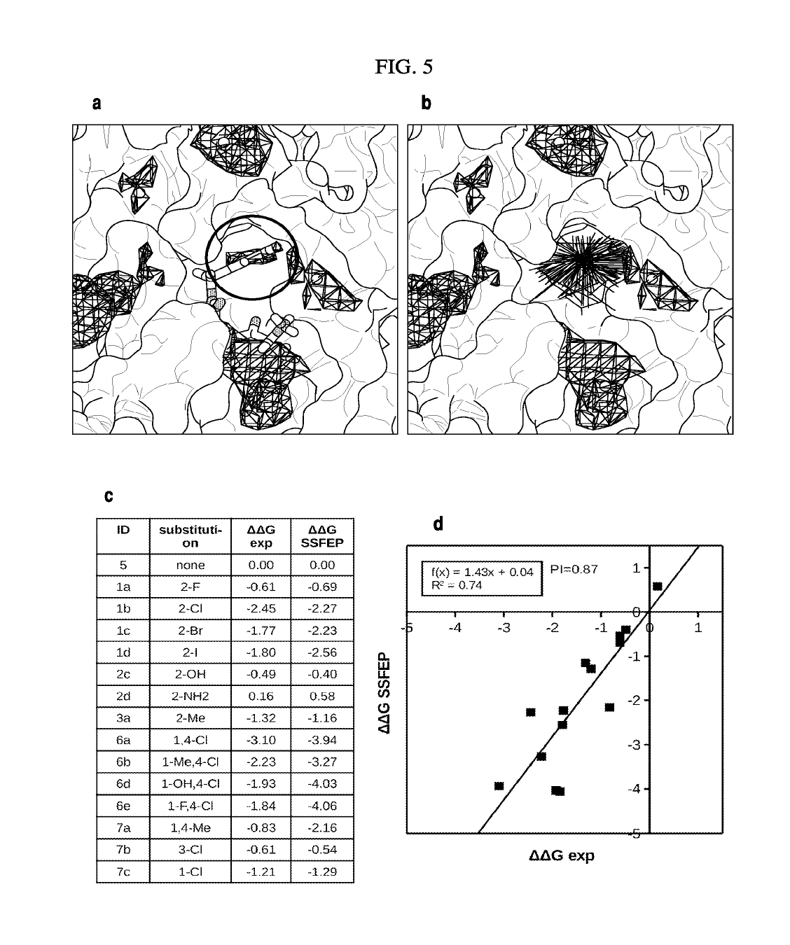

First, the benzene FragMap in the grid free energy (GFE) representation was created using the last 5 ns of the 10 published 20 ns long SILCS trajectories. Grid centers having a free energy value below a threshold of −1.2 kcal/mol were clustered and the cluster centers identified. FIG. 5a, where the cluster centers are represented by green spheres, shows that the FragMaps identify the S1-pocket which coincides with the location of the substituted phenyl group in ATI. From the SILCS simulation trajectories, all benzene (and the corresponding environment) conformations are selected for which any benzene carbon atom is closer than 3 Å from the cluster center in the S1-pocket. This leads to selection of benzene molecules in the S1-pocket, while still sampling a relatively broad ensemble of conformations required for the SSFEP calculations. Applying this procedure resulted in 605 snapshots being selected from the SILCS simulations, for which the respective benzene conformations are displayed in FIG. 5b. The SSFEP protocol was applied to this ensemble. The reference benzene conformation used to generate different rotations of each ligand was the same as above, and the predicted changes in the free energy of binding of ATI were subsequently estimated using the SSFEP approach. FIGS. 5c and d show that trends in the experimental relative binding free energies are well reproduced with an R² value of 0.74. The relatively high predictive index of 0.87 indicates that the predictions rank most pairs correctly.

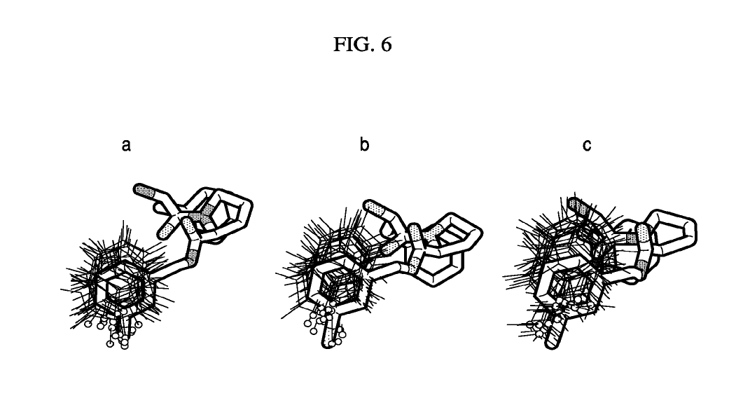

The utility of the SSFEP method lies not just in identifying favorable chemical modifications but also geometries as noted previously in the one-step perturbation implementation. There exist X-ray co-crystal structures of thrombin in complex with three inhibitors of the fourteen analyzed above, namely 1a, 1b and 3a (defined in FIG. 3), which correspond to flurobenzene, chlorobenzene and toluene, respectively. As discussed above, for these ligands the location of the substitution can be at two distinct positions R2 or R4. The SSFEP calculations based on the SILCS simulations for all three analogues predict the R2 position to be more favorable than R4. From the R2 position SSFEP calculations, the top 20 most favorable conformations, as quantified by most negative ΔE_{analogue-benzene} values, were selected and are shown for flurobenzene, chlorobenzene and toluene in FIGS. 6a, b and c, respectively. Overlaid on each panel are the crystal conformations of the corresponding ligand. The agreement with the crystal structures shows that the SSFEP calculations correctly identified the R2 substitution location. In fact, the R2 substitution is the most favorable of the six, with ΔΔG_{benzene→analogue}^{bind} values of −2.67 and −1.54 kcal/mol for chlorobenzene and toluene, respectively. For flurobenzene, the substitution at the R2 position is less favorable (−1.03 kcal/mol) than the R5 position (−1.80 kcal/mol), but nevertheless still favorable. Somewhat expectedly, the next most favorable position for chlorine substitution after R2 is R5 at −1.68 kcal/mol. In agreement with this prediction, compound 6a has two chlorine substitutions at positions R2 and R5 and is the highest affinity ligand in the dataset. There exists a crystal structure (PDB 1TA2) of a ligand very similar to ATI, which has a double chlorine substitution at R2 and R5 position in agreement with our prediction.

Since this protocol is designed for use in an exploratory context, which does not assume the availability of an existing crystal structure to serve as a reference, the sensitivity of the results to the choice of reference benzene conformation (used to assign the six possible rotational states to the benzene analogues) was tested. Two reference conformations were arbitrarily selected from the 605 benzene snapshots and named them ref2 and ref3, respectively. In addition, a fourth conformation, ref4, was selected, which shows the best overlap with the benzene FragMap that was constructed from the SILCS simulation data. Figure S3 in the supporting information shows these conformations, which have RMSDs of 0.98, 1.25 and 1.30 Å, respectively, with respect to the original reference conformation; i.e. the conformation of the phenyl ring in ATI (named ref1). Figure S3 shows that there is good agreement between the four different sets of the predicted 42 values (6 orientations×7 ligands) of ΔΔG_{benzene→analogue}^{bind} as evidenced by the correlation plots between ref1-ref2, ref1-ref3 and ref1-ref4. Few differences are seen, mostly for unfavorably predicted values, which will not be of potential interest in the subsequent drug design process. Thus, the predictions are not highly sensitive to the choice of the reference conformation and the method can therefore be used in an exploratory context.

Application of the SSFEP Protocol to SILCS Simulation Data of P38MK

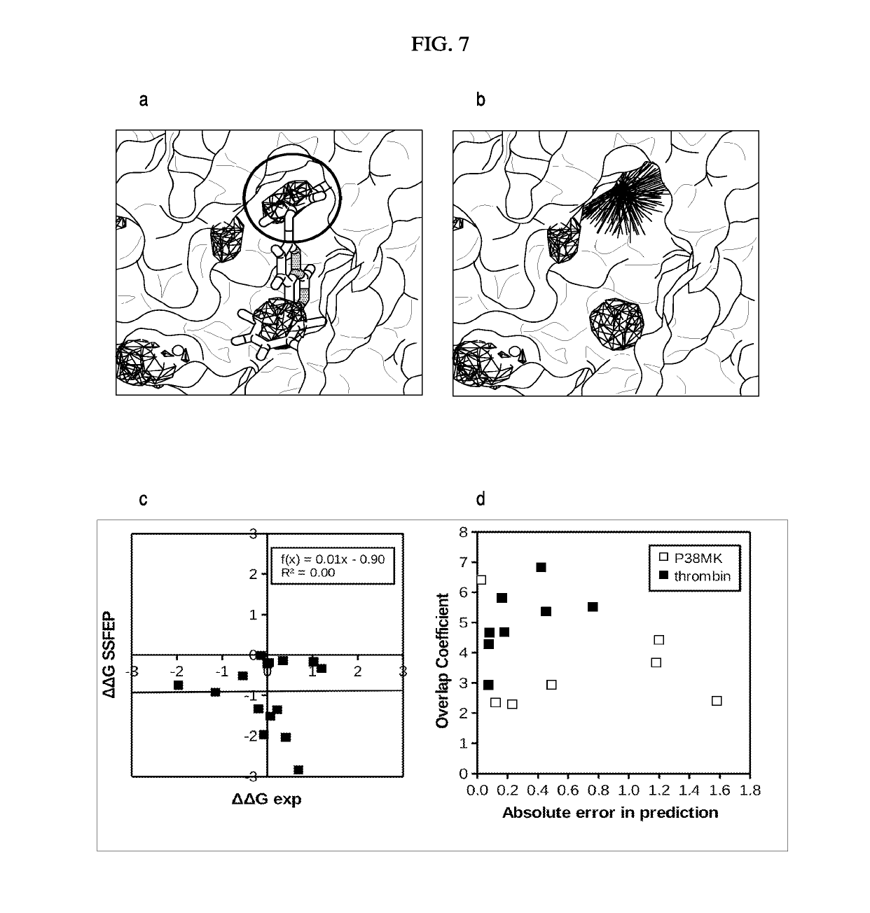

The protocol as applied above to thrombin was followed for P38MK. Starting from the crystal conformation, ten trajectories of SILCS simulations were performed for 10 ns each. The last 5 ns segment of each trajectory was used for benzene FragMap construction. FIG. 7a displays the overlay of the crystal conformation of MKI with the benzene FragMaps, which correctly identify the substituted phenyl ring of the inhibitor, in addition to the other di-chloro substituted phenyl ring. The low free energy grid centers with GFE<−1.2 kcal/mol were clustered, with the centers of the clusters shown as green spheres in the figure. From the cluster corresponding to the inhibitor, 1000 snapshots (shown in FIG. 7b) were obtained and were subject to the SSFEP protocol with the same reference benzene conformation as used before. FIG. 7c shows that this results in poor predictability of the experimental data. The reason for this may be the flexibility issues associated with this system as discussed above, in combination with the lack of the intra-ligand constraints caused by the SILCS-based sampling having been performed with a benzene molecule instead of the full ligand. These factors would combine to lead to the conformational ensemble of the benzene molecule in the binding pocket not being representative of that of the phenyl ring in inhibitor MKI, thereby leading to poor agreement with the experimental data.

To test the consistency of benzene conformational distribution from the SILCS simulation with that of the phenyl ring in the full inhibitor, the following analysis was performed. From the first MD simulation trajectory of the MKI-P38MK complex with the protein restrained, the phenyl ring atoms from the snapshots of the simulation were binned into 1 Å³ cubic volume elements, forming a 3D probability grid of the ring carbon atoms in the binding pocket. Next, the 50 top conformations of 7 singly substituted analogues in each orientation separately that contribute most favorably to the relative binding free energy were selected, and the overlap of these conformations was computed with the full-ligand phenyl carbon probability grid. For some ligands there were less than 50 conformations that have a negative (ie. favorable) ΔE_{analogue-benzene}, such that only the favorable conformations were included. To quantify the extent of overlap, an overlap coefficient (“OC”) is defined as follows.

$$OC = \frac{1}{N} {\sum }_{i = 1}^{N} min {\{ grad ( {x}_{i , j} , {y}_{i , j} , {z}_{i , j} ) \}}_{j = 1}^{6} \qquad ( 7 )$$

In equation 7, for any conformation i out of N (≦50), the grid( ) function returns the grid occupancy value at the x_{i,j},y_{i,j},z_{i,j} position of each ring carbon atom j. A minimum of the occupancy is considered over the six ring atoms j, as this measure is more sensitive to the level of inconsistency between the probability grid and conformations analyzed than any other measures such as the average of the occupancy values. In FIG. 7d, the OC (normalized to % values) computed for 7 analogues involving a single substitution is plotted vs. absolute errors in the prediction of ΔΔG_{benzene→analogue}^{bind}. For analogues that involve two alternate conformations in the binding pocket, OC was computed only for the more favorable conformation as judged by the ΔΔG_{benzene→analogue}^{bind} value. The red squares show the OC values for the 7 P38MK ligands. As a comparison, similar analysis was performed for 8 thrombin ligands involving a single substitution. OC values of the thrombin ligands are shown as blue squares. In general, the OC values are higher for thrombin, indicating that the benzene spatial distributions overlap better with those of the phenyl moiety from the ligand ATI as compared to P38MK. Correspondingly, the errors in the predicted free energies arc lower for thrombin. Moreover, based on the general distribution of the ATI and P38MK data points taken together, it is apparent that the spread in prediction becomes higher as the OC becomes lower; i.e. the data points are roughly evenly distributed below an imaginary line going from the top left to the bottom right of the figure. This analysis supports the hypothesis that the inconsistency of the SILCS simulation ensemble of benzene orientations for P38MK with that of the phenyl moiety in the full-ligand simulation is the reason for the poor prediction. Indeed, this limitation is inherent in fragment based drug discovery in general, as discussed below.

Discussion

In one embodiment, the methods and systems described herein make it possible to rapidly identify favorable modifications to fragments that are explicitly sampled in SILCS simulations by using SSFEP calculations applied to a selected conformational subspace. Several approximations and assumptions are made. The first approximation is that of alchemical free energy perturbations performed in a single step, which have the potential to lead to non-overlapping phase space of the two end states. The agreement obtained with experimental hydration and binding free energies suggests that despite this approximation, the method can rank ligands reasonably correctly in the case of single heavy atom modifications. In previous studies it has been noted that it may be difficult to obtain accurate results using the SSFEP method when the end states differ significantly in polar character due to differing environmental responses. In the hydration free energy test case, there was a tendency for the SSFEP method to underestimate the free energy decrease upon addition of polar groups to benzene, though the addition of polar groups was properly predicted to lead to more favorable free energies of solvation vs. non-polar substituents, leading to the relatively high R² and PI values (FIG. 2).

The second approximation involved the removal of rotation and the separate free energy evaluations of each of the 6 orientations. The underlying assumption in this approximation is that as fragment complexity increases; i.e. as the symmetric benzene molecule is transformed to a substituted analogue, the binding orientation is expected to become specific. Free energy evaluations of orientations separately could neglect enthalpic and entropic contributions arising from other orientations. However, in the context in which this method is to be used, the subsequent linking of fragments into drug-like molecules, where free rotation of the phenyl ring will not he possible or at least restricted due to linkage, this approximation is necessary. Indeed, having separate free energy values for different orientations is exactly what is desired in a subsequent fragment-linking step, which is not straightforward to obtain from traditional free energy methods such as TI, unless additional restraints are applied. For P38MK, the SSFEP results involving the full-ligand simulations were seen to be in much better agreement with the experiment when the calculation was performed after rotation removal. This again shows the importance of this step to account for the lack of specificity that the unsubstituted phenyl ring would have, which may not yield an ensemble consistent with the substitution.

The third approximation is that the effect of multiple simultaneous substitutions is treated in an additive manner. For the thrombin dataset, a significantly higher correlation (R²=0.91) was obtained when only considering the 9 singly substituted analogues (data not shown) showing the limitations of this approximation. Instead of using the additive assumption, the present inventors initially attempted to introduce the simultaneous substitutions in the SSFEP calculations itself, but failed to obtain a close correspondence with the experimental results. Without wishing to be bound by theory, this is believed to be due to the failure to find simultaneously favorable benzene-environment conformations for the multiple substitutions in the solution and/or in protein environment within the time scale of the unperturbed simulation. Similar observations have been made before in the soft-core based one-step perturbation method. Thus, the methodology in the present protocol is expected to be most applicable to single heavy atom substitutions. Further investigation into sampling is required to extend it to predictions of multiple simultaneous heavy atom substitutions.

Finally, even though the method aims to identify fragments, the test set used for validating binding free energy predictions involved large drug-sized molecules due to availability of data and also keeping in mind the fact that the fragment detection step is followed by linking fragments into drug-sized molecules. SSFEP calculations on thrombin SILCS simulation results reproduced the experimental data of the full α-thrombin ligands to a reasonable extent. The predictions are much more accurate than those made from the SSFEP calculations applied to the full-ligand simulation. This is likely due to the optimal benzene-environment conformations generated in the SILCS simulations, which may also yield more representative water distributions on the protein surface as the removal of overlapping crystal water molecules during the generation of thrombin-ATI complex structure has the potential to lead to inaccuracies. For P38MK, the SSFEP calculations performed on the SILCS simulation data did not predict the experimental data. This appears to be due to the non-overlapping conformational spaces of benzene from the SILCS simulation with that of the phenyl ring in the P38MK binding pocket due to the presence of the remainder of the ligand. Thus, the disagreement with experiment is due to contributions arising from linkage with other fragments—an inherent limitation of both experimental and theoretical fragment based methods. Simply, if the linking of fragments in a full ligand does not significantly perturb the conformational space sampled by the individual fragments, predictions made based on the individual fragments will more likely be valid. Accordingly, contributions arising from fragment linkage need to be accounted for in fragment linking methods, which must carefully use geometries and energetic contributions only from those conformations which are consistent with the linkage.

The key advantage of the method described herein, for example, SSFEP method in combination with SILCS is efficiency. SILCS calculations require about a week on 10×8 processors to obtain ten 10 ns simulations of a system with ˜23,500 atoms, from which the FragMaps and GFEs for hydrogen bond donors and acceptors, aliphatics and aromatics were obtained. These data can be used in manifold ways towards drug design as detailed previously. Extending this dataset to a range of substituted benzene analogs required 1.5 hours on 20 single cores of a typical commodity cluster, a process that involved the use of 1000 conformations to evaluate the SSFEP free energy changes of 8 ligands in 6 orientations. It is expected that the protocol should be applicable with minor modifications to fragments other than benzene that involve single heavy atom substitutions, though this remains to be tested. This would lead to rapid expansion of chemical space of fragments while requiring explicit sampling only for a few and at minimal additional computational costs.

Conclusions

Presented is a method that identifies favorable fragment binding sites by analyzing protein-fragment SILCS MD or Monte Carlo simulations, followed by selecting the relevant conformational subspace pertaining to a protein site of interest. Single step free energy perturbation (SSFEP) calculations performed on the resultant ensemble identify chemical modifications to the bound fragments and corresponding orientations that are predicted to result in a gain in binding free energy. The SSFEP calculations were first validated using experimental hydration free energies of benzene analogues as target data. Relative binding free energies were computed for two sets of ligands of the proteins α-thrombin and P38 MAP kinase (P38MK) differing only in phenyl ring substitutions. The SSFEP protocol applied to the ensemble obtained from protein-ligand complex MD simulations showed modest ability in rank ordering ligands based on affinity. The protocol was then applied to thrombin SILCS simulation data and the calculated relative free energies of the phenyl analogues show good agreement with experimental data. For P38MK, it was shown that the results of benzene analogues cannot be compared to experimental data of the full drug sized ligand due to the conformational distributions of the benzene ring in these two contexts being different, a problem not observed with thrombin. Contributions due to fragment linkage, an important problem in fragment based methods, need to be carefully considered in the subsequent fragment-linking algorithm. It is expected that with minor modifications, the methodology can be applicable to other rigid fragments that can be sampled in SILCS simulations, though this remains to be tested. As the present protocol is a post-processing method, it allows for site-specific favorable modifications of fragments to be rapidly identified, thus enhancing the utility of SILCS simulations.

Application of the SSFEP Protocol to SILCS Simulation Data of S100B and p53 Protein Interaction

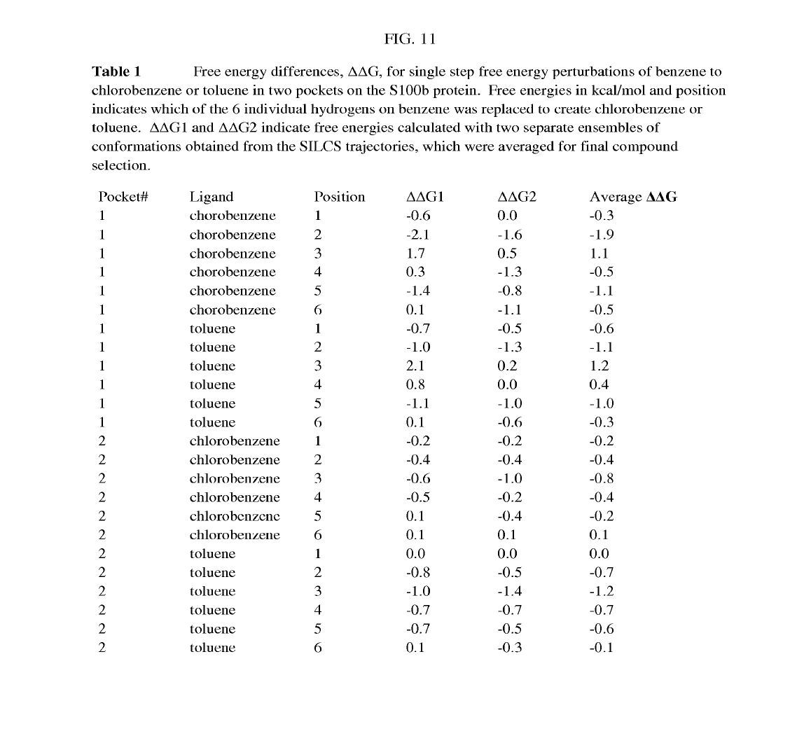

The SSFEP protocol was applied to the computer aided design of inhibitors of the S100B-p53 protein-protein interaction. SILCS simulations were performed starting from the crystal conformation of the S100B protein and the low free energy binding regions of benzene and propane fragments were identified. The benzene FragMaps were clustered and centers of the fragment affinity were identified for several binding sites on the surface of the S100B protein. The SSFEP protocol was then applied to calculate the change in the free energy of binding for selected analogs of benzene in 3 sites located in the region of the protein S100B that interfaces with p53. The SSFEP calculations were performed independently for each of the 3 sites and screened 8 benzene analogues (fluorobenzene, chlorobenzene, bromobenzene, iodobenzene, toluene, phenol, aniline and pyridine). SSFEP calculations were performed using two ensembles of benzene molecules extracted from the SILCS simulations. Only Chloro- and methyl substituted benzenes (chlorobenzene and toluene, respectively) were identified as having affinity greater than benzene in pockets 1 and 2, as shown in Table 1 in FIG. 11. Those analogs with average free energies less than −1 kcal/mol were selected for the design of S100B inhibitors using a fragment based approach.

The entire contents of each of the following references is hereby incorporated by reference.

Erlanson, D. A.; McDowell, R. S.; O'Brien, T. J. Med. Chem. 2004, 47, 3463-3482.

Murray, C. W.; Rees, D. C. Nat. Chem. 2009, 1, 187-92.

Guvench, O.; MacKerell, A. D., Jr. PLoS Comput. Biol. 2009, 5, e1000435.

Miranker, A.; Karplus, M. Proteins 1991, 11, 29-34.

Majeux, N.; Scarsi, M.; Apostolakis, J.; Ehrhardt, C.; Caflisch, A. Proteins 1999, 37, 88-105.

Raman, E. P.; Yu, W.; Guvench, O.; MacKerell, A. D., Jr. J. Chem. Inf. Model. 2011, 51, 877-96.

Kulp, J. L.; Pompliano, D. L.; Guarnieri, F. J. Am. Chem. Soc., 133, 10740-3.

Dey, F.; Caflisch, A. J. Chem. Inf. Model. 2008, 48, 679-90.

Clark, M.; Meshkat, S.; Talbot, G. T.; Carnevali, P.; Wiseman, J. S. J. Chem. Inf. Model. 2009, 49, 1901-13.

Leis, S.; Zacharias, M. J. Comput. Chem. 2011, 32, 3433-3439.

Huang, D.; Caflisch, A. J. Mol. Recognit. 2010, 23, 183-93.

Genheden, S.; Mikulskis, P.; Hu, L.; Kongsted, J.; Soderhjelm, P.; Ryde, U. J. Am. Chem. Soc., 133, 13081-13092.

Wang, S.; Yang, C.-Y. ACS Med. Chem. Lett. 2011, 2, 280-284.

Lexa, K. W.; Carlson, H. A. J. Am. Chem. Soc. 2011, 133, 200-202.

Liu, H.; Mark, A. E.; Gunsteren, W. F. v. J. Phys. Chem. 1996, 100, 9485-9494.

Oostenbrink, C.; van Gunsteren, W. F. Proteins 2004, 54, 237-46.

Mordasini, T. Z.; McCammon, J. A. J. Phys. Chem. B 2000, 104, 360-367.

Oostenbrink, C.; van Gunsteren, W. F. Proc. Natl. Acad. Sci. USA 2005, 102, 6750-6754.

Oostenbrink, C.; van Gunsteren, W. F. J. Comput. Chem. 2003, 24, 1730-1739.

Zwanzig, R. W. J. Chem. Phys. 1954, 22, 1420.

Brooks, B. R.; Brooks III, C. L.; MacKerell Jr., A. D.; Nilsson, L.; Petrella, R. J.; Roux, B.; Won, Y.; Archontis, G.; Bartels, C.; Boresch, S.; Caflisch, A.; Caves, L.; Cui, Q.; Dinner, A. R.; Feig, M.; Fischer, S.; Gao, J.; Hodoscek, M.; Im, W.; Kuczera, K.; Lazaridis, T.; Ma, J.; Ovchinnikov, V.; Paci, E.; Pastor, R. W.; Post, C. B.; Pu, J. Z.; Schaefer, M.; Tidor, B.; Venable, R. M.; Woodcock, H. L.; Wu, X.; Yang, W.; York, D. M.; Karplus, M. J. Comput. Chem. 2009, 30, 1545-1614.

MacKerell, A. D., Jr.; Bashford, D.; Bellott, M.; Dunbrack, R. L.; Evanseck, J. D.; Field, M. J.; Fischer, S.; Gao, J.; Guo, H.; Ha, S.; Joseph-McCarthy, D.; Kuchnir, L.; Kuczera, K.; Lau, F. T. K.; Mattos, C.; Michnick, S.; Ngo, T.; Nguyen, D. T.; Prodhom, B.; Reiher, W. L.; Roux, B.; Schlenkrich, M.; Smith, J. C.; Stote, R.; Straub, J.; Watanabe, M.; Wiórkiewicz-Kuczera, J.; Yin, D.; Karplus, M. J. Phys. Chem. B 1998, 102, 3586-3616.

MacKerell, A. D., Jr.; Feig, M.; Brooks, C. L., 3rd J. Comput. Chem. 2004, 25, 1400-15.

Durell, S. R.; Brooks, B. R.; Ben-Naim, A. J. Phys. Chem. 1994, 98, 2198-2202.

Vanommeslaeghe, K.; Hatcher, E.; Acharya, C.; Kundu, S.; Zhong, S.; Shim, J.; Darian, E.; Guvench, O.; Lopes, P.; Vorobyov, I.; MacKerell, A. D., Jr. J. Comput. Chem. 2010, 31, 671-690.

Vanommeslaeghe, K.; Raman, E. P.; MacKerell Jr., A. D. in preparation 2012.

Word, J. M.; Lovell, S. C.; Richardson, J. S.; Richardson, D. C. J. Mol. Biol. 1999, 285, 1735-1747.

Levitt, M.; Lifson, S. J. Mol. Biol. 1969, 46, 269-279.

Allen, M. P.; Tildesley, D. J. Computer Simulation of Liquids; Oxford University Press: Oxford, 1987.

Ryckaert, J. P.; Ciccotti, O.; Berendsen, H. J. C. J. Comput. Phys. 1977, 23, 327-341.

Darden, T.; York, D.; Pedersen, L. J. Chem. Phys. 1993, 98, 10089-10092.

Steinbach, P. J.; Brooks, B. R. J. Comput. Chem. 1994, 15, 667-683.

Andersen, H. C. J. Chem. Phys. 1980, 72, 2384-2393.

Nosé, S. Mol. Phys. 1984, 52, 255-268.

Hoover, W. G. Phys. Rev. A 1985, 31, 1695-1697.

Feller, S. E.; Zhang, Y. H.; Pastor, R. W.; Brooks, B. R. J. Chem. Phys. 1995, 103, 4613-4621.

Luccarelli, J.; Michel, J.; Tirado-Rives, J.; Jorgensen, W. L. J Chem Theory Comput 2010, 6, 3850-3856.

Jorissen, R. N.; Reddy, G. S.; Ali, A.; Altman, M. D.; Chellappan, S.; Anjum, S. G.; Tidor, B.; Schiffer, C. A.; Rana, T. M.; Gilson, M. K. J Med Chem 2009, 52, 737-54.

Pearlman, D. A.; Charifson, P. S. J Med Chem 2001, 44, 3417-23.

Morton, A.; Matthews, B. W. Biochemistry 1995, 34, 8576-88.

Mobley, D. L.; Bayly, C. 1.; Cooper, M. D.; Shirts, M. R.; Dill, K. A. J Chem Theory Comput 2009, 5, 350-358.

Baum, B.; Mohamed, M.; Zayed, M.; Gerlach, C.; Heine, A.; Hangauer, D.; Klebe, G. J Mol Biol 2009, 390, 56-69.

Tucker, T. J.; Brady, S. F.; Lumma, W. C.; Lewis, S. D.; Gardell, S. J.; Naylor-Olsen, A. M.; Yan, Y.; Sisko, J. T.; Stauffer, K. J.; Lucas, B. J.; Lynch, J. J.; Cook, J. J.; Stranieri, M. T.; Holahan, M. A.; Lyle, E. A.; Baskin, E. P.; Chen, I. W.; Dancheck, K. B.; Krueger, J. A.; Cooper, C. M.; Vacca, J. P. J Med Chem 1998, 41, 3210-9.

Free, S. M., Jr.; Wilson, J. W. J Med Chem 1964, 7, 395-9.

Clark, M.; Meshkat, S.; Talbot, G. T.; Carnevali, P.; Wiseman, J. S. J Chem Inf Model 2009, 49, 1901-13.

What is claimed is:

1. A method for estimating the difference between binding free energies of molecules, said method carried out on a computer and comprising:
carrying out a molecular dynamics simulation or a Monte Carlo simulation on a large molecule and at least one small molecule, wherein the small molecule is not an unphysical reference state, to obtain multiple conformations of said large and small molecules in a binding environment of the large molecule;
determining an energy of the small molecule in said binding environment for said conformations;
replacing one or more atoms of said small molecule with one or more different atoms for each of said conformations, to obtain a modified small molecule in said binding environment;
determining an energy of the modified small molecule in said binding environment for said conformations, wherein a molecular dynamics simulation or Monte Carlo simulation is not carried out on said modified small molecule; and
carrying out a single step perturbation calculation using said energies of the small and modified small molecules, to obtain the estimated difference between the binding free energies of said small and modified small molecules to said large molecule.

2. The method of claim 1, wherein the large molecule is selected from the group consisting of nucleotide, oligonucleotide, DNA, single-stranded DNA, RNA, carbohydrate, glycolipid, protein, glycoprotein, receptor, phospholipid, ribosomal protein, antibody, F(ab) fragment, F(ab)₂ fragment, chimeric antibody, humanized antibody, human antibody, peptide, aptamer, complex thereof, ligand-bound complex thereof, fragment-bound complex thereof, ligand-binding domain thereof, binding site thereof, surface thereof, and combination thereof.

3. The method of claim 1, wherein the large molecule has a molecular weight of 50 to 500,000 Da.

4. The method of claim 1, wherein the large molecule is a carbohydrate, glycolipid, protein, glycoprotein, phospholipid, ribosomal protein, peptide, aptamer, or combination thereof.

5. The method of claim 1, wherein the small molecule does not have soft-core interactions.

6. The method of claim 1, wherein the small molecule has unperturbed non-bonded interactions.

7. The method of claim 1, wherein the small molecule is water, functional group, or a hydrocarbon.

8. The method of claim 1, wherein In one embodiment, the small molecule is a straight or branched, acyclic or cyclic, saturated or unsaturated, substituted or unsubstituted, aromatic or non-aromatic C₁-C₂₀ hydrocarbon.

9. The method of claim 1, wherein the small molecule has a molecular weight of ≧10 Da.

10. The method of claim 1, wherein the small molecule has a molecular weight of ≧150 Da.

11. The method of claim 1, wherein the binding environment comprises a region within 20 Å or less from any atom on the surface of the large molecule.

12. The method of claim 1, wherein the replacing comprises replacing a hydrogen in the small molecule with a heavy atom, to obtain the modified large molecule.

13. The method of claim 1, wherein the molecular dynamics simulation is carried out.

14. The method of claim 1, wherein the molecular dynamics simulation is CHARMM, SILCS, GROMACS, or OpenMM.

15. The method of claim 1, wherein the Monte Carlo simulation is carried out.

16. The method of claim 1, wherein one or both of the energy of the small molecules in the binding environment for the multiple conformations and the energy of the modified small molecules in the binding environment for the multiple conformations is obtained using CHARMM, GROMACS, or OpenMM.

17. The method of claim 1, wherein a predictive index, PI, of the estimated difference is greater than 0.

18. The method of claim 1, further comprising ranking the small molecule and modified small molecule in order of increasing or decreasing estimated differences between binding free energies.

19. The method of claim 1, wherein the modified small molecule is a first modified small molecule, the method further comprising replacing one or more atoms of said small molecule with one or more different atoms for each of said conformations, to obtain a second modified small molecule in said binding environment, the second modified small molecule being different than the first modified small molecule;
determining an energy of the second modified small molecule in said binding environment for said conformations, wherein a molecular dynamics simulation or Monte Carlo simulation is not carried out on said second modified small molecule; and
carrying out a single step perturbation calculation using said energies of the small and second modified small molecules, to obtain the estimated difference between the binding free energies of said small and second modified small molecules to said large molecule.

20. The method of claim 19, further comprising ranking the small molecule, first modified small molecule, and second modified small molecule in order of increasing or decreasing estimated differences between binding free energies.

21. The method of claim 1, further comprising synthesizing by wet chemical reaction a compound comprising the modified small molecule or portion thereof.

22. A computer readable medium encoded with a computer program for estimating the difference between binding free energies of molecules and comprising:
a means for carrying out a molecular dynamics simulation or a Monte Carlo simulation on a large molecule and at least one small molecule, wherein the small molecule is not an unphysical reference state and obtaining multiple conformations of said large and small molecules in a binding environment of the large molecule;
a means for determining an energy of the small molecule in said binding environment for said conformations;
a means for replacing one or more atoms of said small molecule with one or more different atoms for each of said conformations and obtaining a modified small molecule in said binding environment;
a means for determining an energy of the modified small molecule in said binding environment for said conformations, wherein a molecular dynamics simulation or Monte Carlo simulation is not carried out on said modified small molecule; and
a means for carrying out a single step perturbation calculation using said energies of the small and modified small molecules and obtaining the estimated difference between the binding free energies of said small and modified small molecules to said large molecule.
